(19) United States
(12) Patent Application Publication
(10) Pub. No.: US 2022/0217977 A1
(43) Pub. Date: Jul. 14, 2022

(54) ULV FORMULATIONS WITH ENHANCED UPTAKE

(71) Applicant: Bayer Aktiengesellschaft, Leverkusen (DE)

(72) Inventors: Malcolm FAERS, Düsseldorf (DE); Arno RATSCHINSKI, Düsseldorf (DE); Andreas RÖCHLING, Langenfeld (DE); Gorka PERIS URQUIJO, Köln (DE); Oliver GAERTZEN, Köln (DE); Emilia HILZ, Haan (DE); Sybille LAMPRECHT, Leverkusen (DE); Elisabeth ASMUS, Hösbach (DE); Udo BICKERS, Köln (DE); Silvia CEREZO-GALVEZ, Langenfeld (DE)

(73) Assignees: Bayer Aktiengesellschaft, Leverkusen (DE); Bayer Aktiengesellschaft, Leverkusen (DE)

(21) Appl. No.: 17/609,650

(22) PCT Filed: May 8, 2020
(86) PCT No.: PCT/EP2020/062918

§ 371 Date: Nov. 8, 2021

(30) Foreign Application Priority Data
May 8, 2019 (EP) 17193402.9
May 8, 2019 (EP) 19173403.7
May 8, 2019 (EP) 19173404.5

(51) Int. Cl. A01N 25/30; A01N 25/06; A01N 43/56; A01N 43/653; A01N 43/80; A01N 37/50; A01N 47/06; A01N 43/38; A01N 43/713; A01N 43/50; A01N 43/66; A01N 35/06

(52) U.S. Cl. CPC A01N 25/30; A01N 25/06; A01N 43/56; A01N 43/653; A01N 43/80; A01N 37/50; B64D 1/18; A01N 43/38; A01N 43/713; A01N 43/50; A01N 43/66; A01N 35/06; A01N 47/06

(57) ABSTRACT

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, 10 weeds or diseases, in particular on waxy leaves.

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, weeds or diseases, in particular on waxy leaves.

Modern agriculture faces many challenges in producing sufficient food in a safe and sustainable way. There is therefore a need to utilise crop protection products to enhance the safety, quality and yield while minimising the impact to the environment and agricultural land. Many crop protection products, whether chemical or biological, are normally applied at relatively high spray volumes, for example in selected cases >50 L/ha, and often >150-400 L/ha. A consequence of this is that much energy must be expended to carry the high volume of spray liquid and then apply it to the crop by spray application. This can be performed by large tractors which on account of their weight and also the weight of the spray liquid produce CO₂ from the mechanical work involved and also cause detrimental compaction of the soil, affecting root growth, health and yield of the plants, as well as the energy subsequently expended in remediating these effects.

There is a need for a solution that significantly reduces the high volumes of spray liquid and reduces the weight of the equipment required to apply the product.

In agriculture, low spray volume application technologies including unmanned aerial systems (UAS), unmanned guided vehicles (UGV), and tractor mounted boom sprayers fitted with pulse width modulation spray nozzles or rotating disc droplet applicators are offering farmers solutions to apply products with low spray volumes, typically down to 10 to 20 l/ha or less. These solutions have advantages including for example that they require significantly less water which is important in regions where the supply of water is limited, require less energy to transport and apply the spray liquid, are faster both from quicker filling of the spray tank and faster application, reduce the CO₂ generation from both the reduced volume of spray liquid to transport and from the use of smaller and lighter vehicles, reduced soil compaction damage, and enabling the use of cheaper application systems.

However, Wang et al [Field evaluation of an unmanned aerial vehicle (UAV) sprayer: effect of spray volume on deposition and the control of pests and disease in wheat. Pest Management Science 2019 doi/epdf/10.1002/ps.5321] demonstrated that as the spray volume is decreased from 450 and 225 l/ha to 28.1, 16.8 and 9.0 l/ha, the coverage (% area), number of spray deposits per area, and diameter of the spray deposits as measured on water sensitive paper all decreased (see Table 3 in Wang et al, 2019). In parallel, the biological control efficacy for both wheat aphid control and powdery mildew control decreased at low spray volumes with the greatest decrease observed at 9.0 l/ha, followed by 16.8 l/ha (see FIGS. 6, 7 and 8 in Wang et al, 2019).

Separately Faers and Faers et al identified the importance of annulus structures in leaf spray deposits for the biodelivery of active ingredients in the presence of adjuvants, M. A. Faers [Annulus spray deposit structures and enhanced a.i.—adjuvant association with adjuvanted flowables. Proc 8th International Symposium of Adjuvants for Agrochemicals, ed. by RE Gaskin. International Society for Agrochemical Adjuvants, ISBN 978-0-473-12388-8, 2007], M. A. Faers, R. Pontzen [Factors influencing the association between active ingredient and adjuvant in the leaf deposit of adjuvanted suspo-emulsion formulations. Pest Manag. Sci. 64: 820-833, 2008], M. A. Faers, K. Tsangaris, R. Pontzen, A. Bismarck [Studies on leaf deposit microstructures through changes in colloidal and surface forces. P. Baur, M. Bonnet (Eds.), Proceedings 9th International Symposium on Adjuvants and Agrochemicals, pp. 309-318, ISBN 978-90-815702-1-3, International Society for Agrochemical Adjuvants, Wageningen, The Netherlands, (2010)]. Annulus spray deposit structures, also known as coffee ring structures, exhibited higher uptake of active ingredients and therefore formulation recipes and spray volumes that deliver annulus structures are preferred for improved biodelivery of active ingredients with adjuvants.

There is therefore a need to design formulation systems that overcome the reduction in the coverage and diameter of the spray deposits at low spray volumes also through high uptake.

Therefore, there is a need to provide formulations which, when sprayed at ultra-low spray volumes according to the present invention, that have a good uptake, thus, efficacy is maintained and losses of active ingredient are minimized.

The solution is provided by formulations containing specific uptake enhancers at high concentrations in the solution.

A particular advantage of the invention stemming from the low total amount of additives compared to the level required at normal higher spray volumes is lower cost of formulations and their ease of production. Further advantages include improved formulation stability and simplified manufacture, less cost of goods as well as less impact on the environment.

Formulations, also for tank mixes, known in the prior art containing additives for enhanced uptake are principally designed for much higher spray volumes and generally contain lower concentrations of additives in the spray broth. Nevertheless, due to the high spray volumes used in the prior art, the total amount of additives used and therefore in the environment is higher than according to the present invention.

Further, the concentration of the additives is an important element of the invention, since suitable properties can only be achieved with certain concentrations. However, if the spray volume now is reduced, also the amount of active ingredient is reduced. However, this leads to low volume formulations with such low concentration of additives that sufficient uptake cannot be achieved (see examples).

In this invention, we have surprisingly found that increasing the concentration of the additives indicated above as the spray volume decreases can compensate for the loss in performance (due to insufficient uptake) from the reduction in spray volume. It was surprisingly found that for every reduction of the spray volume by 50%, the concentration of surfactant should roughly be doubled.

Thus, although the absolute concentration of the additives is increased compared to formulations known in the art, the relative total amount per ha can be decreased, which is advantageous, both economically and ecologically, while uptake, rain-fastness and thus efficacy of the formulation according to the invention is improved, maintained or at least kept at an acceptable level when other benefits of the low volume applications are considered, e.g. less costs of formulation due to less cost of goods, smaller vehicles with less working costs, less compacting of soil etc.

In one aspect, the present invention is directed to the use of the compositions according to the invention for foliar application.

If not otherwise indicated, % in this application means percent by weight (% w/w).

It is understood that in case of combinations of various components, the percentages of all components of the formulations always sum up to 100.

Further, if not otherwise indicated, the reference “to volume” for water indicates that water is added to a total volume of a formulation of 1000 ml (11). For the sake of clarity it is understood that if unclear the density of the formulation is understood as to be 1 g/cm³.

In the context of the present invention aqueous based agrochemical compositions comprise at least 5% of water and include suspension concentrates, aqueous suspensions, suspo-emulsions or capsule suspensions, preferably suspension concentrates and aqueous suspensions.

Further, it is understood, that the preferred given ranges of the application volumes or application rates as well as of the respective ingredients as given in the instant specification can be freely combined and all combinations are disclosed herein, however, in a more preferred embodiment, the ingredients are preferably present in the ranges of the same degree of preference, and even more preferred the ingredients are present in the most preferred ranges.

In one aspect, the invention refers to a formulation comprising:
a) One or more active ingredients,
b) One or more uptake enhancer,
c) Other formulants,
d) one or more carriers to volume (1 L or 1 kg),
   wherein b) is present in 5 to 250 g/l.

If not otherwise indicated in the present invention the carrier is usually used to volume the formulation. Preferably, the concentration of carrier in the formulation according to the invention is at least 5% w/w, more preferred at least 10% w/w such as at least 20% w/w, at least 40% w/w, at least 50% w/w, at least 60% w/w, at least 70% w/w and at least 80% w/w or respectively at least 50 g/l, more preferred at least 100 g/l such as at least 200 g/l, at least 400 g/l, at least 500 g/l, at least 600 g/l, at least 700 g/l and at least 800 g/l.

The formulation is preferably a spray application to be used on crops.

In a preferred embodiment according to the present invention, also for the following embodiments in the specification, the carrier is water.

In a preferred embodiment the formulation of the instant invention comprises
a) One or more active ingredients,
b) One or more uptake enhancer,
c1) At least one suitable non-ionic surfactant and/or suitable ionic surfactant,
c2) Optionally, a rheological modifier,
c3) Optionally, a suitable antifoam substance,
c4) Optionally, suitable antifreeze agents,
c5) Optionally, suitable other formulants.
d) carrier to volume,
wherein b) is present in 5 to 250 g/l, and wherein water is even more preferred as carrier.
In another embodiment at least one of c2, c3, c4 and c5 are mandatory, preferably, at least two of c2, c3, c4 and c5 are mandatory, and in yet another embodiment c2, c3, c4 and c5 are mandatory.
In a preferred embodiment component a) is preferably present in an amount from 5 to 300 g/l, preferably from 10 to 280 g/l, and most preferred from 10 to 250 g/l.
In an alternative embodiment component a) is a fungicide.
In an alternative embodiment component a) is an insecticide.
In an alternative embodiment component a) is a herbicide.
In a preferred embodiment component b) is present in 5 to 250 g/l, preferably from 20 to 200 g/l, and most preferred from 30 to 150 g/l.
In a preferred embodiment component c) is present in 10 to 150 g/l, preferably from 25 to 150 g/l, and most preferred from 30 to 120 g/l.
In a preferred embodiment the one or more component c1) is present in 4 to 250 g/l, preferably from 8 to 120 g/l, and most preferred from 10 to 80 g/l.
In a preferred embodiment the one or more component c2) is present in 0 to 60 g/l, preferably from 1 to 20 g/l, and most preferred from 2 to 10 g/l.
In a preferred embodiment the one or more component c3) is present in 0 to 30 g/l, preferably from 0.5 to 20 g/l, and most preferred from 1 to 12 g/l.
In a preferred embodiment the one or more component c4) is present in 0 to 200 g/l, preferably from 5 to 150 g/l, and most preferred from 10 to 120 g/l.
In a preferred embodiment the one or more component c5) is present in 0 to 200 g/l, preferably from 0.1 to 120 g/l, and most preferred from 0.5 to 80 g/l.

In one embodiment the formulation comprises the components a) to e) in the following amounts
a) from 5 to 300 g/l, preferably from 10 to 280 g/l, and most preferred from 10 to 250 g/l,
b) from 5 to 250 g/l, preferably from 20 to 200 g/l, and most preferred from 30 to 150 g/l,
c) from 4 to 250 g/l, preferably from 8 to 120 g/l, and most preferred from 10 to 80 g/l,
d) carrier to volume.

In another embodiment the formulation comprises the components a) to e) in the following amounts
a) from 5 to 300 g/l, preferably from 10 to 280 g/l, and most preferred from 10 to 250 g/l,
b) from 5 to 250 g/l, preferably from 20 to 200 g/l, and most preferred from 30 to 150 g/l,
c1) from 4 to 250 g/l, preferably from 8 to 120 g/l, and most preferred from 10 to 80 g/l,
c2) from 0 to 60 g/l, preferably from 1 to 20 g/l, and most preferred from 2 to 10 g/l,
c3) from 0 to 30 g/l, preferably from 0.5 to 20 g/l, and most preferred from 1 to 12 g/l,
c4) from 0 to 200 g/l, preferably from 5 to 150 g/l, and most preferred from 10 to 120 g/l,
c5) from 0 to 200 g/l, preferably from 0.1 to 120 g/l, and most preferred from 0.5 to 80 g/l,
d) carrier to volume.

It is understood that in case a solid carrier is used, the above referenced amounts refer to 1 kg instead of to 11, i.e. g/kg.

As indicated above, component d) is always added to volume, i.e. to 11 or 1 kg.

In a further preferred embodiment of the present invention the formulation consists only of the above described ingredients a) to f) in the specified amounts and ranges.

In a preferred embodiment the herbicide is used in combination with a safener, which is preferably selected from the group comprising isoxadifen-ethyl and mefenpyr-diethyl.

The instant invention further applies to a method of application of the above referenced formulations, wherein the formulation is applied at a spray volume of between 1 and 20 l/ha, preferably 2 and 15 l/ha, more preferably 5 and 15 l/ha.

More preferred, the instant invention applies to a method of application of the above referenced formulations, wherein the formulation is applied at a spray volume of between 1 and 20 l/ha, preferably 2 and 15 l/ha, more preferably 5 and 15 l/ha, and the amount of b) is present in from 5 to 250 g/l, preferably from 20 to 200 g/l, and most preferred from 30 to 150 g/l, and most preferred from 10 to 130 g/, wherein in a further preferred embodiment a) is present f from 5 to 300 g/l, preferably from 10 to 280 g/l, and most preferred from 10 to 250 g/1.

In another aspect the instant invention applies to a method of application of the above referenced formulations,

wherein the formulation is applied at a spray volume of between 1 and 20 l/ha, preferably 2 and 15 l/ha, more preferably 5 and 15 l/ha, and
wherein preferably the applied amount of a) to the crop is between 2 and 150 g/ha, preferably between 5 and 120 g/ha, and more preferred between 20 and 100 g/ha.

Further, the spreading agent b) is preferably applied from 5 g/ha to 150 g/ha, more preferably from 7.5 g/ha to 100 g/ha, and most preferred from 10 g/ha to 60 g/ha.

In one embodiment, the with the above indicated method applied amount of a) to the crop is between 2 and 10 g/ha.

In another embodiment, the with the above indicated method applied amount of a) to the crop is between 40 and 110 g/ha.

In one embodiment in the applications described above, the active ingredient (ai) a) is preferably applied from 2 and 150 g/ha, preferably between 5 and 120 g/ha, and more preferred between 20 and 100 g/ha, while correspondingly the spreading agent is preferably applied from 10 g/ha to 100 g/ha, more preferably from 20 g/ha to 80 g/ha, and most preferred from 40 g/ha to 60 g/ha.

In particular the formulations of the instant invention are useful for application with a spray volume of between 1 and 20 l/ha, preferably 2 and 15 l/ha, more preferably 5 and 15 l/ha on plants or crops with textured leaf surfaces, preferably on wheat, barley, rice, rapeseed, soybean (young plants) and cabbage.

Further, the instant invention refers to a method of treating crops with textured leaf surfaces, preferably wheat, barley, rice, rapeseed, soybean (young plants) and cabbage, with a spray volume of between 1 and 20 l/ha, preferably 2 and 15 l/ha, more preferably 5 and 15 l/ha.

In a preferred embodiment the above described applications are applied on crops with textured leaf surfaces, preferably on wheat, barley, rice, rapeseed, soybean (young plants) and cabbage.

In one embodiment the active ingredient is a fungicide or a mixture of two fungicides or a mixture of three fungicides.

In another embodiment the active ingredient is an insecticide or a mixture of two insecticides or a mixture of three insecticides.

In yet another embodiment the active ingredient is a herbicide or a mixture of two herbicides or a mixture of three herbicides, wherein preferably in the mixtures on mixing partner is a safener.

In the context of the present invention, suitable formulation types are by definition suspension concentrates, aqueous suspensions, suspo-emulsions or capsule suspensions, emulsion concentrates, water dispersible granules, oil dispersions, emulsifiable concentrates, dispersible concentrates, wettable granules, preferably suspension concentrates, aqueous suspensions, suspo-emulsions and oil dispersions, wherein in the case of non-aqueous formulations or solid formulations the sprayable formulation are obtained by adding water.

### Active Ingredients (a):

The active compounds identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current IRAC Mode of Action Classification Scheme at the time of filing of this patent application.

Examples of fungicides (a) according to the invention are:

1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chloro-cyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichloro-phenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluoro-phenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]-phenoxy}phenyl)-N-ethyl-N-methylimidoformamide, (1.068) N′-(2,5-dimethyl-4-{3-[(2,2,2-trifluoro-ethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimido-formamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropyl-cyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimido-formamide, (1.081) ipfentrifluconazole, (1.082) 2-[4-(4-chlorophenoxy)-2-(trifluoromethyl)phenyl]-1-(1H-1,2,4-triazol-1-yl)propan-2-ol, (1.083) 2-[6-(4-bromophenoxy)-2-(trifluoromethyl)-3-pyridyl]-1-(1,2,4-triazol-1-yl)propan-2-ol, (1.084) 2-[6-(4-chlorophenoxy)-2-(trifluoromethyl)-3-pyridyl]-1-(1,2,4-triazol-1-yl)propan-2-ol, (1.085) 3-[2-(1-chlorocyclopropyl)-3-(3-chloro-2-fluoro-phenyl)-2-hydroxy-propyl]imidazole-4-carbonitrile, (1.086) 4-[[6-[rac-(2R)-2-(2,4-difluorophenyl)-1,1-difluoro-2-hydroxy-3-(5-thioxo-4H-1,2,4-triazol-1-yl)propyl]-3-pyridyl]oxy]benzonitrile, (1.087) N-isopropyl-N′-[5-methoxy-2-methyl-4-(2,2,2-trifluoro-1-hydroxy-1-phenylethyl)phenyl]-N-methylimidoformamide, (1.088) N′-{5-bromo-2-methyl-6-[(1-propoxypropan-2-yl)oxy]pyridin-3-yl}-N-ethyl-N-methylimido-formamide, (1.089) hexaconazole, (1.090) penconazole, (1.091) fenbuconazole.
2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) inpyrfluxam, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)-pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne, (2.058) N-[rac-(1S,2S)-2-(2,4-dichlorophenyl)cyclobutyl]-2-(trifluoromethyl)-nicotinamide, (2.059) N-[(1S,2S)-2-(2,4-dichlorophenyl)cyclobutyl]-2-(trifluoromethyl)nicotinamide.
3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) fenpicoxamid, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.
4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) pyridachlometyl, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine, (4.026) fluopimomide.
5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper (2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.
6) Compounds capable to induce a host defence, for example (6.001) acibenzolar-S-methyl, (6.002) isotianil, (6.003) probenazole, (6.004) tiadinil.
7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.
8) Inhibitors of the ATP production, for example (8.001) silthiofam.
9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.
10) Inhibitors of the lipid and membrane synthesis, for example (10.001) propamocarb, (10.002) propamocarb hydrochloride, (10.003) tolclofos-methyl.
11) Inhibitors of the melanin biosynthesis, for example (11.001) tricyclazole, (11.002) tolprocarb. 12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).
13) Inhibitors of the signal transduction, for example (13.001) fludioxonil, (13.002) iprodione, (13.003) procymidone, (13.004) proquinazid, (13.005) quinoxyfen, (13.006) vinclozolin.
14) Compounds capable to act as an uncoupler, for example (14.001) fluazinam, (14.002) meptyldinocap.
15) Further fungicides selected from the group consisting of (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)-phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoro-methyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) ipflufenoquin, (15.042) 2-{2-fluoro-6-[(8-fluoro-2-methylquinolin-3-yl)oxy]phenyl}propan-2-ol, (15.043) fluoxapiprolin, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]-pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimido-formamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) methyl {4-[5-(trifluoromethyl)-1,2,4-oxadiazol-3-yl]phenyl}carbamate, (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyiminomethyl]-4-[5-(trifluoromethyl)-1,2,4-oxadiazol-3-yl]benzamide, (15.078) N-[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoro-methyl)-1,2,4-oxadiazol-3-yl]benzamide, (15.084) N-[(Z)-N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]propanamide, (15.086) 4,4-dimethyl-1-[[4-[5-(trifluoromethyl)-1,2,4-oxadiazol-3-yl]phenyl]methyl]pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoro-methyl}-1,2,4-oxadiazol-3-yl]phenyl]methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phen-yl]methyl]propanamide, (15.093) N-methoxy-N-[[4-[5-(trifluoromethyl)-1,2,4-oxadiazol-3-yl]phenyl]-methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropanecarboxamide, (15.096) N,2-dimethoxy-N-[[4-[5-(trifluoromethyl}-1,2,4-oxadiazol-3-yl]phenyl]methyl]propanamide, (15.097) N-ethyl-2-methyl-N-[[4-[5-(trifluoromethyl)-1,2,4-oxadiazol-3-yl)phenyl]methyl]propanamide, (15.098) 1-methoxy-3-methyl-1-[[4-[5-(trifluoro-methyl)-1,2,4-oxadiazol-3-yl]phenyl]methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]-methyl]piperidin-2-one, (15.102) 4,4-dimethyl-2-[[4-[5-(trifluoromethyl)-1,2,4-oxadiazol-3-yl]phenyl]-methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 1-[[3-fluoro-4-(5-(trifluoromethyl)-1,2,4-oxadiazol-3-yl]-phenyl]methyl]azepan-2-one, (15.106) 4,4-dimethyl-2-[[4-(5-(trifluoromethyl)-1,2,4-oxadiazol-3-yl]-phenyl]methyl]isoxazolidin-3-one, (15.107) 5,5-dimethyl-2-[[4-[5-(trifluoromethyl)-1,2,4-oxadiazol-3-yl]phenyl]methyl]isoxazolidin-3-one, (15.108) ethyl 1-{4-[5-(trifluoromethyl)-1,2,4-oxadiazol-3-yl]benzyl}-1H-pyrazole-4-carboxylate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide, (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydro-isoquinoline, (15.115) 1-(5-(fluoromethyl)-6-methyl-pyridin-3-yl)-4,4-difluoro-3,3-dimethyl-3,4-dihydroisoquinoline, (15.116) 1-(6-(difluoromethyl)-5-methoxy-pyridin-3-yl)-4,4-difluoro-3,3-dimethyl-3,4-dihydroisoquinoline, (15.117) 4-[5-(trifluoromethyl)-1,2,4-oxadiazol-3-yl]phenyl dimethyl-carbamate, (15.118) N-{4-[5-(trifluoromethyl)-1,2,4-oxadiazol-3-yl]phenyl}propanamide, (15.119) 3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.120) 9-fluoro-3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.121) 3-[2-(1-{[3,5-bis(difluoromethyl)-1H-pyrazol-1-yl]acetyl}piperidin-4-yl)-1,3-thiazol-4-yl]-1,5-dihydro-2,4-benzodioxepin-6-yl methanesulfonate, (15.122) 3-[2-(1-{[3,5-bis(difluoromethyl)-1H-pyrazol-1-yl]acetyl}piperidin-4-yl)-1,3-thiazol-4-yl]-9-fluoro-1,5-dihydro-2,4-benzodioxepin-6-yl methanesulfonate, (15.123) 1-(6,7-dimethylpyrazolo[1,5-a]pyridin-3-yl)-4,4-difluoro-3,3-dimethyl-3,4-dihydroisoquinoline, (15.124) 8-fluoro-N-(4,4,4-trifluoro-2-methyl-1-phenylbutan-2-yl)quinoline-3-carboxamide, (15.125) 8-fluoro-N-[(2S)-4,4,4-trifluoro-2-methyl-1-phenylbutan-2-yl]quinoline-3-carboxamide, (15.126) N-(2,4-dimethyl-1-phenylpentan-2-yl)-8-fluoroquinoline-3-carboxamide and (15.127) N-[(2S)-2,4-dimethyl-1-phenylpentan-2-yl]-8-fluoroquinoline-3-carboxamide.

Examples of insecticides (a) according to the invention are:

(1) Acetylcholinesterase (AChE)-inhibitors, e.g. Carbamates Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC and an Xylylcarb, or organophosphates, e.g. Acephat, Azamethiphos, Azinphos-ethyl, Azinphos-methyl, Cadusafos, Chlorethoxyfos, Chlorfenvinphos, Chlormephos, Chlorpyrifos-methyl, Coumaphos, Cyanophos, Demeton-S-methyl, Diazinon, Dichlorvos/DDVP, Dicrotophos, Dimethoat, Dimethylvinphos, Disulfoton, EPN, Ethion, Ethoprophos, Famphur, Fenamiphos, Fenitrothion, Fenthion, Fosthiazat, Heptenophos, Imicyafos, Isofenphos, Isopropyl-O-(methoxyaminothio-phosphoryl)salicylat, Isoxathion, Malathion, Mecarbam, Methamidophos, Methidathion, Mevinphos, Monocrotophos, Naled, Omethoate, Oxydemeton-methyl, Parathion-methyl, Phenthoat, Phorat, Phosalon, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Triclorfon and Vamidothion.
(2) GABA-gated chloride channel antagonists, preferably Cyclodien-organochlorine selected from the group of Chlordan and Endosulfan, or Phenylpyrazole (Fiprole) selected from Ethiprol and Fipronil.
(3) Sodium channel modulators/voltage-dependent sodium channel blockers, for example pyrethroids, e.g. Acrinathrin, Allethrin, d-cis-trans Allethrin, d-trans Allethrin, Bifenthrin, Bioallethrin, Bioallethrin S-cyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, theta-Cypermethrin, zeta-Cypermethrin, Cyphenothrin [(1R)-trans isomers], Deltamethrin, Empenthrin [(EZ)-(1R) isomers), Esfenvalerate, Etofenprox, Fenpropathrin, Fenvalerate, Flucythrinate, Flumethrin, tau-Fluvalinate, Halfenprox, Imiprothrin, Kadethrin, Momfluorothrin, Permethrin, Phenothrin [(1R)-trans isomer), Prallethrin, Pyrethrine (pyrethrum), Resmethrin, Silafluofen, Tefluthrin, Tetramethrin, Tetramethrin [(1R) isomers)], Tralomethrin and Transfluthrin or DDT or Methoxychlor.
(4) Nicotinic acetylcholine receptor (nAChR) competitive activators, preferably Neonicotinoids selected from Acetamiprid, Clothianidin, Dinotefuran, Imidacloprid, Nitenpyram, Thiacloprid and Thiamethoxam, or Nicotin, or Sulfoximine selected from Sulfoxaflor, or Butenolide selected from Flupyradifurone, or Mesoionics selected from Triflumezopyrim.
(5) Nicotinic acetylcholine receptor (nAChR) allosteric activators, preferably Spinosynes selected from Spinetoram and Spinosad.
(6) Allosteric modulators of the glutamate-dependent chloride channel (GluCl), preferablyAvermectine/Milbemycine selected from Abamectin, Emamectin-benzoate, Lepimectin and Milbemectin.
(7) Juvenile hormone mimetics, preferably Juvenile hormon-analogs selected from Hydropren, Kinopren and Methopren, or Fenoxycarb or Pyriproxyfen.
(8) Various non-specific (multi-site) inhibitors, preferably Alkylhalogenides selected from Methylbromide and other Alkylhalogenides, or Chloropicrin or Sulfurylfluorid or Borax or Tartar emetic or Methylisocyanate generators selected from Diazomet and Metam.
(9) TRPV channel modulators of chordotonal organs selected from Pymetrozin and Pyrifluquinazon.
(10) Mite growth inhibitors selected from Clofentezin, Hexythiazox, Diflovidazin and Etoxazol.
(11) Microbial disruptors of the insect intestinal membrane selected from Bacillus thuringiensis Subspezies israelensis, Bacillus sphaericus, Bacillus thuringiensis Subspezies aizawai, Bacillus thuringiensis Subspezies kurstaki, Bacillus thuringiensis subspecies tenebrionis and B.t.-plant proteins selected from Cry1Ab, Cry1Ac, Cry1Fa, Cry1A.105, Cry2Ab, VIP3A, mCry3A, Cry3Ab, Cry3Bb and Cry34Ab1/35Ab1.
(12) Mitochondrial ATP synthase inhibitors, preferably ATP-disruptors selected from Diafenthiuron, or Organo-tin-compounds selected from Azocyclotin, Cyhexatin and Fenbutatin-oxid, or Propargit or Tetradifon.
(13) Decoupler of oxidative phosphorylation by disturbance of the proton gradient selected from Chlorfenapyr, DNOC and Sulfluramid.
(14) Nicotinic acetylcholine receptor channel blocker selected from Bensultap, Cartap-hydrochlorid, Thiocyclam and Thiosultap-Sodium.
(15) Inhibitors of chitin biosynthesis, Typ 0, selected from Bistrifluron, Chlorfluazuron, Diflubenzuron, Flucycloxuron, Flufenoxuron, Hexaflumuron, Lufenuron, Novaluron, Noviflumuron, Teflubenzuron and Triflumuron.
(16) Inhibitors of chitin biosynthesis, Typ 1 selected from Buprofezin.
(17) Molting disruptor (especially dipteras, i.e. two-winged insects) selected from Cyromazin.
(18) Ecdyson receptor agonists selected from Chromafenozid, Halofenozid, Methoxyfenozid and Tebufenozid.
(19) Octopamin-receptor-agonists selected from Amitraz.
(20) Mitochondrial complex III electron transport inhibitors selected from Hydramethylnon, Acequinocyl and Fluacrypyrim.
(21) Mitochondrial complex I electron transport inhibitors, preferably so-called METI-acaricides selected from Fenazaquin, Fenpyroximat, Pyrimidifen, Pyridaben, Tebufenpyrad and Tolfenpyrad, or Rotenon (Derris).
(22) Blocker of the voltage-dependent sodium channel selected from Indoxacarb and Metaflumizone.
(23) Inhibitors of acetyl-CoA carboxylase, preferably tetronic and tetramic acid derivatives selected from Spirodiclofen, Spiromesifen, Spirotetramat and Spidoxamate (IUPAC Name: 11-(4-chloro-2,6-xylyl)-12-hydroxy-1,4-dioxa-9-azadispiro [4.2.4.2]tetradec-11-en-10-one).
(24) Mitochondrial complex IV electron transport inhibitors, preferably Phosphines selected from Aluminiumphosphid, Calciumphosphid, Phosphin and Zinkphosphid, or Cyanides selected from Calciumcyanid, Potassiumcyanid and Sodiumcyanid.
(25) Mitochondrial complex II electron transport inhibitors, preferably beta-Ketonitril derivate selected from Cyenopyrafen and Cyflumetofen, or Carboxanilide selected from Pyflubumid.
(28) Ryanodinreceptor-modulators, preferably Diamide selected from Chlorantraniliprol, Cyantraniliprol and Flubendiamid.
(29) Modulators of chordotonal organs (with undefined target structure) selected from Flonicamid.
(30) other active ingredients selected from Acynonapyr, Afidopyropen, Afoxolaner, Azadirachtin, Benclothiaz, Benzoximat, Benzpyrimoxan, Bifenazat, Broflanilid, Bromopropylat, Chinomethionat, Chloroprallethrin, Cryolit, Cyclaniliprol, Cycloxaprid, Cyhalodiamid, Dicloromezotiaz, Dicofol, Dimpropyridaz, epsilon-Metofluthrin, epsilon-Momfluthrin, Flometoquin, Fluazaindolizin, Fluensulfon, Flufenerim, Flufenoxystrobin, Flufiprol, Fluhexafon, Fluopyram, Flupyrimin, Fluralaner, Fluxametamid, Fufenozid, Guadipyr, Heptafluthrin, Imidaclothiz, Iprodione, Isocycloseram, kappa-Bifenthrin, kappa-Tefluthrin, Lotilaner, Meperfluthrin, Oxazosulfyl, Paichongding, Pyridalyl, Pyrifluquinazon, Pyriminostrobin, Spirobudiclofen, Spiropidion, Tetramethylfluthrin, Tetraniliprol, Tetrachlorantraniliprol, Tigolaner, Tioxazafen, Thiofluoximat and Iodmethan; products from Bacillus firmus (I-1582, BioNeem, Votivo), as well as following compounds: 1-{2-Fluor-4-methyl-5-[(2,2,2-trifluorethyl)sulfinyl]phenyl}-3-(trifluormethyl)-1H-1,2,4-triazol-5-amin (known from WO2006/043635) (CAS 885026-50-6), {1′-[(2E)-3-(4-Chlorphenyl)prop-2-en-1-yl]-5-fluorspiro[indol-3,4′-piperidin]-1(2H)-yl}(2-chlorpyridin-4-yl)methanon (known from WO2003/106457) (CAS 637360-23-7), 2-Chlor-N-[2-{1-[(2E)-3-(4-chlorphenyl)prop-2-en-1-yl]piperidin-4-yl}-4-(trifluormethyl)phenyl]isonicotinamid (known from WO2006/003494) (CAS 872999-66-1), 3-(4-Chlor-2,6-dimethylphenyl)-4-hydroxy-8-methoxy-1,8-diazaspiro[4.5]dec-3-en-2-on (known from WO 2010052161) (CAS 1225292-17-0), 3-(4-Chlor-2, 6-dimethylphenyl)-8-methoxy-2-oxo-1,8-diazaspiro[4.5]dec-3-en-4-yl-ethylcarbonat (known from EP 2647626) (CAS-1440516-42-6), 4-(But-2-in-1-yloxy)-6-(3,5-dimethylpiperidin-1-yl)-5-fluoropyrimidin (known from WO2004/099160) (CAS 792914-58-0), PF1364 (known from JP2010/018586) (CAS-Reg. No. 1204776-60-2), (3E)-3-[1-[(6-Chlor-3-pyridyl)methyl]-2-pyridyliden]-1,1,1-trifluorpropan-2-on (known from WO2013/144213) (CAS 1461743-15-6), N-[3-(Benzylcarbamoyl)-4-chlorphenyl]-1-methyl-3-(pentafluorethyl)-4-(trifluormethyl)-1H-pyrazol-5-carboxamid (known from WO2010/051926) (CAS 1226889-14-0), 5-Brom-4-chlor-N-[4-chlor-2-methyl-6-(methylcarbamoyl)phenyl]-2-(3-chlor-2-pyridyl)pyrazol-3-carboxamid (known from CN103232431) (CAS 1449220-44-3), 4-[5-(3,5-Dichlorphenyl)-4,5-dihydro-5-(trifluormethyl)-3-isoxazolyl]-2-methyl-N-(cis-1-oxido-3-thietanyl)benzamid, 4-[5-(3,5-Dichlorphenyl)-4,5-dihydro-5-(trifluormethyl)-3-isoxazolyl]-2-methyl-N-(trans-1-oxido-3-thietanyl)benzamid and 4-[(5S)-5-(3,5-Dichlorphenyl)-4,5-dihydro-5-(trifluormethyl)-3-isoxazolyl]-2-methyl-N-(cis-1-oxido-3-thietanyl)benzamid (known from WO 2013/050317 A1) (CAS 1332628-83-7), N-[3-Chlor-1-(3-pyridinyl)-1H-pyrazol-4-yl]-N-ethyl-3-[(3,3,3-trifluorpropyl)sulfinyl]propanamid, (+)-N-[3-Chlor-1-(3-pyridinyl)-1H-pyrazol-4-yl]-N-ethyl-3-[(3,3,3-trifluorpropyl)sulfinyl]propanamid and (−)-N-[3-Chlor-1-(3-pyridinyl)-1H-pyrazol-4-yl]-N-ethyl-3-[(3,3,3-trifluorpropyl)sulfinyl]propanamid (known from WO 2013/162715 A2, WO 2013/162716 A2, US 2014/0213448 A1) (CAS 1477923-37-7), 5-[[(2E)-3-Chlor-2-propen-1-yl]amino]-1-[2,6-dichlor-4-(trifluormethyl)phenyl]-4-[(trifluormethyl)sulfinyl]-1H-pyrazol-3-carbonitrile (known from CN 101337937 A) (CAS 1105672-77-2), 3-Brom-N-[4-chlor-2-methyl-6-[(methylamino)thioxomethyl]phenyl]-1-(3-chlor-2-pyridinyl)-1H-pyrazol-5-carboxamid, (Liudaibenjiaxuanan, known from CN 103109816 A) (CAS 1232543-85-9); N-[4-Chlor-2-[[(1,1-dimethylethyl)amino]carbonyl]-6-methylphenyl]-1-(3-chlor-2-pyridinyl)-3-(fluormethoxy)-1H-pyrazol-5-carboxamid (known from WO 2012/034403 A1) (CAS 1268277-22-0), N-[2-(5-Amino-1,3,4-thiadiazol-2-yl)-4-chlor-6-methylphenyl]-3-brom-1-(3-chlor-2-pyridinyl)-1H-pyrazol-5-carboxamid (known from WO 2011/085575 A1) (CAS 1233882-22-8), 4-[3-[2,6-Dichlor-4-[(3,3-dichlor-2-propen-1-yl)oxy]phenoxy]propoxy]-2-methoxy-6-(trifluormethyl)pyrimidin (known from CN 101337940 A) (CAS 1108184-52-6); (2E)- and 2(Z)-2-[2-(4-Cyanophenyl)-1-[3-(trifluormethyl)phenyl]ethyliden]-N-[4-(difluormethoxy)phenyl]hydrazincarboxamid (known from CN 101715774 A) (CAS 1232543-85-9); Cyclopropancarbonsaure-3-(2,2-dichlorethenyl)-2,2-dimethyl-4-(1H-benzimidazol-2-yl)phenylester (known from CN 103524422 A) (CAS 1542271-46-4); (4aS)-7-Chlor-2,5-dihydro-2-[[(methoxycarbonyl)[4-[(trifluormethyl)thio]phenyl]amino]carbonyl]indeno[1,2-e][1,3,4]oxadiazin-4a(3H)-carbonsäuremethylester (known from CN 102391261 A) (CAS 1370358-69-2); 6-Desoxy-3-O-ethyl-2,4-di-O-methyl-1-[N-[4-[1-[4-(1,1,2,2,2-pentafluorethoxy)phenyl]-1H-1,2,4-triazol-3-yl]phenyl]carbamat]-α-L-mannopyranose (known from US 2014/0275503 A1) (CAS 1181213-14-8); 8-(2-Cyclopropylmethoxy-4-trifluormethylphenoxy)-3-(6-trifluormethylpyridazin-3-yl)-3-azabicyclo[3.2.1]octan (CAS 1253850-56-4), (8-anti)-8-(2-Cyclopropylmethoxy-4-trifluormethylphenoxy)-3-(6-trifluormethylpyridazin-3-yl)-3-azabicyclo[3.2.1]octan (CAS 933798-27-7), (8-syn)-8-(2-Cyclopropylmethoxy-4-trifluormethylphenoxy)-3-(6-trifluormethylpyridazin-3-yl)-3-azabicyclo[3.2.1]octan (known from WO 2007040280 A1, WO 2007040282 A1) (CAS 934001-66-8), N-[3-Chlor-1-(3-pyridinyl)-1H-pyrazol-4-yl]-N-ethyl-3-[(3,3,3-trifluorpropyl)thio]-propanamid (known from WO 2015/058021 A1, WO 2015/058028 A1) (CAS 1477919-27-9) and N-[4-(Aminothioxomethyl)-2-methyl-6-[(methylamino)carbonyl]phenyl]-3-bromo-1-(3-chloro-2-pyridinyl)-1H-pyrazol-5-carboxamid (known from CN 103265527 A) (CAS 1452877-50-7), 5-(1,3-Dioxan-2-yl)-4-[[4-(trifluormethyl)phenyl]methoxy]-pyrimidin (known from WO 2013/115391 A1) (CAS 1449021-97-9), 3-(4-Chlor-2,6-dimethylphenyl)-8-methoxy-1-methyl-1,8-diazaspiro[4.5]decane-2,4-dion (known from WO 2014/187846 A1) (CAS 1638765-58-8), 3-(4-Chlor-2,6-dimethylphenyl)-8-methoxy-1-methyl-2-oxo-1,8-diazaspiro[4.5]dec-3-en-4-yl-carbonsäureethylester (known from WO 2010/066780 A1, WO 2011151146 A1) (CAS 1229023-00-0), 4-[(5S)-5-(3,5-Dichlor-4-fluorophenyl)-4,5-dihydro-5-(trifluoromethyl)-3-isoxazolyl]-N-[(4R)-2-ethyl-3-oxo-4-isoxazolidinyl]-2-methyl-benzamid (known from WO 2011/067272, WO2013/050302) (CAS 1309959-62-3).

Examples of herbicides a) according to the invention are:

Acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-5-fluoro-6-(7-fluoro-1H-indol-6-yl)pyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bixlozone, bromacil, bromobutide, bromofenoxim, bromoxynil, bromoxynil-butyrate, -potassium, -heptanoate, and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, 1-{2-chloro-3-[(3-cyclopropyl-5-hydroxy-1-methyl-1H-pyrazol-4-yl)carbonyl]-6-(trifluormethyl)phenyl}piperidin-2-on, 4-{2-chloro-3-[(3,5-dimethyl-1H-pyrazol-1-yl)methyl]-4-(methylsulfonyl)benzoyl}-1,3-dimethyl-1H-pyrazol-5-yl-1,3-dimethyl-1H-pyrazol-4-carboxylat, chlorfenac, chlorfenac-sodium, chlorfenprop, chlorflurenol, chlorflurenol-methyl, chloridazon, chlorimuron, chlorimuron-ethyl, 2-[2-chloro-4-(methylsulfonyl)-3-(morpholin-4-ylmethyl)benzoyl]-3-hydroxycyclohex-2-en-1-on, 4-{2-chloro-4-(methylsulfonyl)-3-[(2,2,2-trifluorethoxy)methyl]benzoyl}-1-ethyl-1H-pyrazol-5-yl-1,3-dimethyl-1H-pyrazol-4-carboxylat, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, -2-ethylhexyl, -isobutyl, -isooctyl, -isopropylammonium, -potassium, -triisopropanolammonium, and -trolamine, 2,4-DB, 2,4-DB-butyl, -dimethylammonium, -isooctyl, -potassium, and -sodium, daimuron (dymron), dalapon, dazomet, n-decanol, desmedipham, detosyl-pyrazolate (DTP), dicamba, dichlobenil, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, 3-(2,6-dimethylphenyl)-6-[(2-hydroxy-6-oxocyclohex-1-en-1-yl)carbonyl]-1-methylchinazolin-2,4(1H,3H)-dion, 1,3-dimethyl-4-[2-(methylsulfonyl)-4-(trifluormethyl)benzoyl]-1H-pyrazol-5-yl-1,3-dimethyl-1H-pyrazol-4-carboxylat, dimetrasulfuron, dinitramine, dinoterb, diphenamid, diquat, diquat-dibromid, dithiopyr, diuron, DMPA, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, ethyl-[(3-{2-chloro-4-fluoro-5-[3-methyl-2,6-dioxo-4-(trifluormethyl)-3,6-dihydropyrimidin-1(2H)-yl]phenoxy}pyridin-2-yl)oxy]acetat, F-9960, F-5231, i.e. N-{2-chloro-4-fluoro-5-[4-(3-fluoropropyl)-5-oxo-4,5-dihydro-1H-tetrazol-1-yl]phenyl}ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, fluro-chloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium, and -trimesium, H-9201, i.e. 0-(2,4-dimethyl-6-nitrophenyl)O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl) ethyl-(2,4-dichlorophenoxy)acetate, 4-hydroxy-1-methoxy-5-methyl-3-[4-(trifluormethyl)pyridine-2-yl]imidazolidine-2-on, 4-hydroxy-1-methyl-3-[4-(trifluormethyl)pyridine-2-yl]imidazolidine-2-on, (5-hydroxy-1-methyl-1H-pyrazol-4-yl)(3,3,4-trimethyl-1,1-dioxido-2,3-dihydro-1-benzothiophen-5-yl)methanon, 6-[(2-hydroxy-6-oxocyclohex-1-en-1-yl)carbonyl]-1,5-dimethyl-3-(2-methylphenyl)chinazolin-2,4(1H,3H)-dion, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, keto-spiradox, lactofen, lenacil, linuron, MCPA, MCPA-butotyl, -dimethylammonium, -2-ethylhexyl, -isopropylammonium, -potassium, and -sodium, MCPB, MCPB-methyl, -ethy,l and -sodium, mecoprop, mecoprop-sodium, and -butotyl, mecoprop-P, mecoprop-P-butotyl, -dimethylammonium, -2-ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, 2-({2-[(2-methoxyethoxy)methyl]-6-(trifluormethyl)pyridin-3-yl}carbonyl)cyclohexan-1,3-dion, methyl isothiocyanate, 1-methyl-4-[(3,3,4-trimethyl-1,1-dioxido-2,3-dihydro-1-benzothiophen-5-yl)carbonyl]-1H-pyrazol-5-ylpropan-1-sulfonat, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-(3-chloro-4-isopropylphenyl)-2-methylpentan amide, NGGC-011, napropamide, NC-310, i.e. [5-(benzyloxy)-1-methyl-1H-pyrazol-4-yl](2,4-dichlorophenyl)-methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxy-carbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimi-sulfan, pyrithiobac, pyrithiobac-sodium, pyroxasulfone, pyroxsulam, quinclorac, quinmerac, quino-clamine, quizalofop, quizalofop-ethyl, quizalofop-P, quizalofop-P-ethyl, quizalofop-P-tefuryl, QYM-201, QYR-301, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trichloroacetic acid), TCA-sodium, tebuthiuron, tefuryltrione, tembotrione, tepraloxydim, terbacil, terbucarb, terbumeton, terbuthylazin, terbutryn, tetflupyrolimet, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, ZJ-0862, i.e. 3,4-dichloro-N-{2-[(4,6-dimethoxypyrimidin-2-yl)oxy]benzyl}aniline.

The at least one active ingredient is preferably selected from the group comprising fungicides selected from the group comprising classes as described here above (1) Inhibitors of the respiratory chain at complex, in particular azoles, (2) Inhibitors of the respiratory chain at complex I or II, (3) Inhibitors of the respiratory chain at complex, (4) Inhibitors of the mitosis and cell division, (6) Compounds capable to induce a host defence, (10) Inhibitors of the lipid and membrane synthesis, and (15).

Further preferred, the at least one active ingredient a) as fungicide is selected from the group comprising bixafen, fluoxapiprolin, inpyrfluxam, isoflucypram, prothioconazole, tebuconazole, trifloxystrobin

The at least one insecticide is preferably selected from the group comprising insecticides selected from the group comprising classes as described here above (2 GABA-gated chloride channel antagonists, (3) Sodium channel modulators/voltage-dependent sodium channel blockers (4) (4) Nicotinic acetylcholine receptor (nAChR) competitive activators, (23) Inhibitors of acetyl-CoA carboxylase, (28) Ryanodinreceptor-modulators, (30) other active ingredients.

also further preferred, the at least one active ingredient a) as insecticide is selected from the group comprising ethiprole, imidacloprid, spidoxamat, spirotetramat, tetraniliprole.

Lastly further preferred, the at least one active ingredient a) as herbicide is selected from the group comprising thiencarbazone-methyl, triafamone, isoxadifen-ethyl and mefenpyr-diethyl.

Even more preferred, the at least one active ingredient is selected from the group comprising bixafen, fluoxapiprolin, inpyrfluxam, isoflucypram, prothioconazole, tebuconazole, trifloxystrobin, ethiprole, imidacloprid, spidoxamat, spirotetramat, tetraniliprole, thiencarbazone-methyl, triafamone, isoxadifen-ethyl and mefenpyr-diethyl.

All named active ingredients as described here above can be present in the form of the free compound or, if their functional groups enable this, an agrochemically active salt thereof.

Furthermore, mesomeric forms as well as stereoisomeres or enantiomeres, where applicable, shall be enclosed, as these modifications are well known to the skilled artisan, as well as polymorphic modifications.

If not otherwise specified, in the present invention solid, agrochemical active compounds a) are to be understood as meaning all substances customary for plant treatment, whose melting point is above 20° C.

### Uptake Enhancers (b)

Oils that function as penetration promoters, suitable oils are all substances of this type which can customarily be employed in agrochemical agents. Preferably, oils of vegetable, mineral and animal origin and alkyl esters of these oils. Examples are:
sunflower oil, rapeseed oil, corn oil, soybean oil, rice bran oil, olive oil;
ethylhexyl oleate, ethylhexyl palmitate, ethylhexyl myristate/laurate, ethylhexyl laurate, ethylhexyl caprylate/caprate, iso-propyl myristate, iso-propyl palmitate, methyl oleate, methyl palmitate, ethyl oleate, rape seed oil methyl ester, soybean oil methyl ester, rice bran oil methyl ester,
Mineral oils, e.g. Exxsol® D100, Solvesso® 200ND, and white oil.
tris-alkyl-phosphate esters, preferably tris (2-ethylhexyl) phosphate, e.g. Disflamoll® TOF:

The uptake enhancer may also be selected from the following group of compounds:
i. ethoxylated branched alcohols (e.g. Genapol® X-type) with 2-20 EO units;
ii. methyl end-capped, ethoxylated branched alcohols (e.g. Genapol® XM-type) comprising 2-20 EO units;
iii. ethoxylated coconut alcohols (e.g. Genapol® C-types) comprising 2-20 EO units;
iv. ethoxylated C12/15 alcohols (e.g. Synperonic® A-types) comprising 2-20 EO units;
v. propoxy-ethoxylated alcohols, branched or linear, e.g. Antarox® B/848, Atlas® G5000, Lucramul® HOT 5902;
vi. propoxy-ethoxylated fatty acids, Me end-capped, e.g. Leofat® 000503M;
vii. alkyl ether citrate surfactants (e.g. Adsee® CE range, Akzo Nobel);
viii. ethoxylated mono- or diesters of glycerine comprising fatty acids with 8-18 carbon atoms and an average of 10-40 EO units (e.g. Crovol® range);
ix. castor oil ethoxylates comprising an average of 5-40 EO units (e.g. Berol® range, Emulsogen® EL range).
x. ethoxylated oleic acid (e.g. Alkamuls® A and AP) comprising 2-20 EO units;
xi. ethoxylated sorbitan fatty acid esters comprising fatty acids with 8-18 carbon atoms and an average of 10-50 EO units (e.g. Arlatone® T, Tween range).

Preferred uptake enhancers according to the present invention are tris (2-ethylhexyl) phosphate, rapeseed oil methyl esters, ethoxylated branched alcohols, ethoxylated coconut alcohols, propoxy-ethoxylated alcohols and mineral oils.

### Other Formulants (c) are

c1 Suitable non-ionic surfactants or dispersing aids c1) are all substances of this type which can customarily be employed in agrochemical agents. Preferably, polyethylene oxide-polypropylene oxide block copolymers, preferably having a molecular weight of more than 6,000 g/mol or a polyethylene oxide content of more than 45%, more preferably having a molecular weight of more than 6,000 g/mol and a polyethylene oxide content of more than 45%, polyethylene glycol ethers of branched or linear alcohols, reaction products of fatty acids or fatty acid alcohols with ethylene oxide and/or propylene oxide, furthermore polyvinyl alcohol, polyoxyalkylenamine derivatives, polyvinylpyrrolidone, copolymers of polyvinyl alcohol and polyvinylpyrrolidone, and copolymers of (meth)acrylic acid and (meth)acrylic acid esters, furthermore branched or linear alkyl ethoxylates and alkylaryl ethoxylates, where polyethylene oxide-sorbitan fatty acid esters may be mentioned by way of example. Out of the examples mentioned above selected classes can be optionally phosphated, sulphonated or sulphated and neutralized with bases.

Possible anionic surfactants c1) are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid.

c2 A rheological modifier is an additive that when added to the recipe at a concentration that reduces the gravitational separation of the dispersed active ingredient during storage results in a substantial increase in the viscosity at low shear rates. Low shear rates are defined as 0.1 s⁻¹ and below and a substantial increase as greater than ×2 for the purpose of this invention. The viscosity can be measured by a rotational shear rheometer.

Suitable rheological modifiers c4) by way of example are:
Polysaccharides including xanthan gum, guar gum and hydroxyethyl cellulose. Examples are Kelzan®, Rhodopol® G and 23, Satiaxane® CX911 and Natrosol® 250 range.
Clays including montmorillonite, bentonite, sepeolite, attapulgite, laponite, hectorite. Examples are Veegum® R, Van Gel® B, Bentone® CT, HC, EW, 34, 38 Pangel® M100, M200, M300, S, M, W, Attagel® 50, Laponite® RD,
Fumed and precipitated silica, examples are Aerosil® 200, Siponat® 22.

Preferred are xanthan gum, montmorillonite clays, bentonite clays and fumed silica.

c3 Suitable antifoam substances c3) are all substances which can customarily be employed in agrochemical agents for this purpose. Silicone oils, silicone oil preparations are preferred. Examples are Silcolapse® 426 and 432 from Bluestar Silicones, Silfoam® SRE and SC132 from Wacker, SAF-184® fron Silchem, Foam-Clear ArraPro-S® from Basildon Chemical Company Ltd, SAG® 1572 and SAG® 30 from Momentive [Dimethyl siloxanes and silicones, CAS No. 63148-62-9]. Preferred is SAG® 1572.

c4 Suitable antifreeze substances are all substances which can customarily be employed in agrochemical agents for this purpose. Suitable examples are propylene glycol, ethylene glycol, urea and glycerine.

c5 Suitable other formulants c5) are selected from biocides, antifreeze, colourants, pH adjusters, buffers, stabilisers, antioxidants, inert filling materials, humectants, crystal growth inhibitors, micronutirients by way of example are:

Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1.2-benzisothiazol-3(2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Possible colourants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Possible pH adjusters and buffers are all substances which can customarily be employed in agrochemical agents for this purpose. Citric acid, sulfuric acid, hydrochloric acid, sodium hydroxide, sodium hydrogen phosphate (Na₂HPO₄), sodium dihydrogen phosphate (NaH₂PO₄), potassium dihydrogen phosphate (KH₂PO₄), potassium hydrogen phosphate (K₂HPO₄), may be mentioned by way of example.

Suitable stabilisers and antioxidants are all substances which can customarily be employed in agrochemical agents for this purpose. Butylhydroxytoluene [3.5-Di-tert-butyl-4-hydroxytoluol, CAS-No. 128-37-0] is preferred.

### Carriers d)

Carriers are those which can customarily be used for this purpose in agrochemical formulations.

A carrier is a solid or liquid, natural or synthetic, organic or inorganic substance that is generally inert, and which may be used as a solvent. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks.

Preferred solid carriers are selected from clays, talc and silica.

Examples of suitable liquid carriers include, but are not limited to, water, organic solvents and combinations thereof. Examples of suitable solvents include polar and nonpolar organic chemical liquids, for example from the classes of
alcohols and polyols (which may optionally also be substituted, etherified and/or esterified, such as ethanol, propanol, butanol, benzylalcohol, cyclohexanol or glycol, 2-ethyl hexanol),
ethers such as dioctyl ether, tetrahydrofuran, dimethyl isosorbide, solketal, cyclopentyl methyl ether, solvents offered by Dow under the Dowanol Product Range e.g. Dowanol DPM, anisole, phenetole, different molecular weight grades of dimethyl polyethylene glycol, different molecular weight grades of dimethyl polypropylene glycol, dibenzyl ether
ketones (such as acetone, methyl ethyl ketone, methyl isobutyl ketone, cyclopentanone, cyclohexanone, cycloheptanone, acetophenone, propiophenone),
lactate esters, such as methyl lactate, ethyl lactate, propyl lactate, butyl lactate, 2-ethyl hexyl lactate
(poly)ethers such as different molecular weight grades of polyethylene glycol, different molecular weight grades of polypropylene glycol
unsubstituted and substituted amines
amides (such as dimethylformamide, or N,N-dimethyl lactamide, or N-formyl morpholine, or fatty acid amides such N,N-dimethyl decanamide or N,N-dimethyl dec-9-en-amide) and esters thereof
lactams (such as 2-pyrrolidone, or N-alkylpyrrolidones, such as N-methylpyrrolidone, or N-butylpyrrolidone, or N-octylpyrrolidone, or N-dodecylpyrrolidone or N-methyl caprolactam, N-alkyl caprolactam)
lactones (such as gamma-butyrolactone, gamma-valerolactone, delta-valerolactone, or alpha-methyl gamma-butyrolactone
sulfones and sulfoxides (such as dimethyl sulfoxide),
nitriles, such as linear or cyclic alkyl nitriles, in particular acetonitrile, cyclohexane carbonitrile, octanonitrile, dodecanonitrile).
linear and cyclic carbonates, such as diethyl carbonate, dipropyl carbonate, dibutyl carbonate, dioctyl carbonate, or ethylene carbonate, propylene carbonate, butylene carbonate, glycerine carbonate

As liquid carrier water is most preferred.

These spray liquids are applied by customary methods, i.e., for example, by spraying, pouring or injecting, in particular by spraying, and most particular by spraying by UAV.

The application rate of the formulations according to the invention can be varied within a relatively wide range. It is guided by the particular active agrochemicals and by their amount in the formulations.

With the aid of the formulations according to the invention it is possible to deliver active agrochemical to plants and/or their habitat in a particularly advantageous way.

The present invention is also directed to the use of agrochemical compositions according to the invention for the application of the agrochemical active compounds contained to plants and/or their habitat.

With the formulations of the invention it is possible to treat all plants and plant parts. By plants here are meant all plants and plant populations, such as desirable and unwanted wild plants or crop plants (including naturally occurring crop plants). Crop plants may be plants which can be obtained by conventional breeding and optimization methods or by biotechnological and gene-technological methods or combinations of these methods, including the transgenic plants and including the plant cultivars which can or cannot be protected by varietal property rights. By plant parts are to be meant all above-ground and below-ground parts and organs of the plants, such as shoot, leaf, flower and root, an exemplary listing embracing leaves, needles, stems, trunks, flowers, fruit bodies, fruits and seeds and also roots, tubers and rhizomes. The plant parts also include harvested material and also vegetative and generative propagation material.

What may be emphasized in this context is the particularly advantageous effect of the formulations according to the invention with regard to their use in cereal plants such as, for example, wheat, oats, barley, spelt, triticale and rye, but also in maize, sorghum and millet, rice, sugar cane, soya beans, sunflowers, potatoes, cotton, oilseed rape, canola, tobacco, sugar beet, fodder beet, asparagus, hops and fruit plants (comprising pome fruit such as, for example, apples and pears, stone fruit such as, for example, peaches, nectarines, cherries, plums and apricots, citrus fruits such as, for example, oranges, grapefruits, limes, lemons, kumquats, tangerines and satsumas, nuts such as, for example, pistachios, almonds, walnuts and pecan nuts, tropical fruits such as, for example, mango, papaya, pineapple, dates and bananas, and grapes) and vegetables (comprising leaf vegetables such as, for example, endives, corn salad, Florence fennel, lettuce, cos lettuce, Swiss chard, spinach and chicory for salad use, cabbages such as, for example, cauliflower, broccoli, Chinese leaves, Brassica oleracea (L.) convar. acephala var. sabellica L. (curly kale, feathered cabbage), kohlrabi, Brussels sprouts, red cabbage, white cabbage and Savoy cabbage, fruit vegetables such as, for example, aubergines, cucumbers, capsicums, table pumpkins, tomatoes, courgettes and sweetcorn, root vegetables such as, for example celeriac, wild turnips, carrots, including yellow cultivars, Raphanus sativus var. niger and var. radicula, beetroot, scorzonera and celery, legumes such as, for example, peas and beans, and vegetables from the Allium family such as, for example, leeks and onions.

The treatment of the plants and plant parts in accordance with the invention with the inventive formulations is carried out directly or by action on their environment, habitat or storage area in accordance with the customary treatment methods, for example by dipping, spraying, vaporizing, atomizing, broadcasting or painting on and, in the case of propagation material, especially seeds, additionally by single or multiple coating.

The active agrochemicals comprised develop a better biological activity than when applied in the form of the corresponding conventional formulations.

### Leaf Surfaces

In Tables 1a and 1b the contact angle of water on leaf surfaces for textured and non-textured is shown.

TABLE 1a
Plants with textured leaves

| | | Contact angle of water ° |
|---|---|---|
| Plant | Species | (adaxial) |
| barley | Hordeum vulgare (var. | 143° |
| | Montoya) | |
| corn, BBCH-11 | Zea mays | 150° |
| corn, BBCH-12 | Zea mays | 149° |
| corn, BBCH-13/14 | Zea mays | 148° |
| soybean, BBCH-12 | Glycine max | 149° |
| soybean, BBCH-13 | Glycine max | 144° |
| rice | Oryza sativa | 180° |
| wheat, BBCH-12 | Triticum aestivum | 148° |
| fat-hen | Chenopodium album | 137° |
| purple crabgrass | Digitaria sanguinalis | 144° |

TABLE 1b
Plants with non-textured leaves

| | | Contact angle of water ° |
|---|---|---|
| Plant | Species | (adaxial) |
| apple | Malus domestica | 104° |
| tomato | Solanum lycopersicum | 106° |
| corn, BBCH-15/16 | Zea mays | 108° |
| corn, BBCH-17 | Zea mays | 107° |
| corn, BBCH-18 | Zea mays | 96° |
| corn, BBCH-19 | Zea mays | 870 |
| velvetleaf | Abutilon theophrasti | 103° |
| redroot pigweed | Amaranthus retroflexus | not measured |

Examples of non-textured crops and plants include tomatoes, peppers, potatoes, carrot, celery, sugar beet, beetroot, spinach, lettuce, beans, peas, clover, apple, pear, peach, apricot, plum, mango, avocado, olive, citrus, orange, lemon, lime, grape, fig, cucumber, melon, water melon, strawberry, raspberry, blueberry, sunflower, pumpkin, soybean (>BBCH XX), corn (>BBCH15), cotton.

Examples of textured crops and plants include garlic, onions, leeks, soybean (<BBCH-XX), oats, wheat, barley, rice, sugarcane, pineapple, banana, linseed, lilies, orchids, corn (<BBCH15), cabbage, brussels sprouts, broccoli, Cauliflower, rye, rapeseed, tulips and peanut.

Examples of non-textured weeds include Abutilon theophrasti, Capsella bursa-pastoris, Datura stramonium, Galium aparine, Ipomoea purpurea, Polygonum lapathifolium, Portulaca oleracea, Senecio vulgaris, Sida spinosa, Sinapis arvensis, Solanum nigrum, Stellaria media, Xanthium orientale, Cyperus rotundus, and Amaranthus retroflexus.

Examples of textured weeds include Cassia obtusifolia, Chenopodium album, Agropyron repens, Alopecurus myosuroides, Apera spica-venti, Avena fatua, Brachiaria plantaginea, Bromus secalinus, Cynodon dactylon, Digitaria sanguinalis, Echinochloa crus-galli, Panicum dichotomiflorum, Poa annua, Setaria faberi and Sorghum halepense.

The invention is illustrated by the following examples.

### EXAMPLES

### Method 1: SC Preparation

The method of the preparation of suspension concentrate formulations are known in the art and can be produced by known methods familiar to those skilled in the art. A 2% gel of the xanthan (c) in water and the biocides (c) was prepared with low shear stirring. The active ingredient (a), non-ionic and anionic dispersants (c), antifoam (c) and other formulants (c) were mixed with water to form a slurry, first mixed with a high shear rotor-stator mixer (Ultra-Turrax®) to reduce the particle size D(v,0.9) to approximately 50 microns, then passed through one or more bead mills (Eiger® 250 Mini Motormill) to achieve a particles size D(v,0.9) typically 1 to 15 microns. Then the additives (b), (c) and (d) and xanthan gel prepared above were added and mixed in with low shear stirring until homogeneous. Finally, the pH is adjusted if needed with acid or base (e).

### Method 2: WG Preparation

The methods of the preparation water dispersible granule formulations are known in the art and can be produced by known methods familiar to those skilled in the art.

For example, to produce a fluid bed granule first a water-based technical concentrate has to be prepared. With low shear stirring all ingredients (a, b and c) like e.g. the active ingredient, surfactants, dispersants, binder, antifoam, spreader, and filler are mixed in water and finally pre-milled in a high shear rotor-stator mixer (Ultra-Turrax®) to reduce the particle size D(v,0.9) to approximately 50 microns, afterwards passed through one or more bead mills (KDL, Bachofen, Dynomill, Bühler, Drais, Lehmann) to achieve a particles size D(v,0.9) typically 1 to 15 microns. This water-based technical concentrate is then spray-dried in a fluid-bed granulation process to form the wettable granules (WG).

The particle size is determined according to CIPAC (CIPAC=Collaborative International Pesticides Analytical Council; www.cipac.org) method MT 187. The particle size distribution is determined by means of laser diffraction. A representative amount of sample is dispersed in degassed water at ambient temperature (self-saturation of the sample), treated with ultrasound (usually 60 s) and then measured in a device from the Malvern Mastersizer series (Malvern Panalytical). The scattered light is measured at various angles using a multi-element detector and the associated numerical values are recorded. With the help of the Fraunhofer model, the proportion of certain size classes is calculated from the scatter data and from this a volume-weighted particle size distribution is calculated. Usually the d50 or d90 value=active ingredient particle size (50 or 90% of all volume particles) is given. The average particle size denotes the d50 value.

Likewise, any other spraying process, like e.g. classical spray drying can be used as granulation method.

A further technique to produce water dispersible granules is for example low pressure extrusion. The ingredients of the formulation are mixed in dry from and are subsequently milled, e.g. using air jet milling to reduce the particle size. Subsequently this dry powder is stirred while water is added to the mixture (approximately 10-30 wt %, dependent on the composition of the formulation). In a further step the mixture is pushed through an extruder (like a dome extruder, double dome extruder, basket extruder, sieve mill, or similar device) with a die size of usually between 0.8 and 1.2 mm to form the extrudates. In a last step the extrudates are post-dried, e.g. in a fluidized bed dryer to reduce the water content of the powder, commonly to a level of 1-3 wt % of residual water.

### Method 3: EC Preparation

The method of the preparation of EC formulations are known in the art and can be produced by known methods familiar to those skilled in the art. In general, EC formulations are obtained by mixing the active ingredient (a) with the rest of the formulation components, which include, amongst others, surfactants (c), spreader (b), a carrier (d) in a vessel equipped with a stirring device. In some cases the dissolving or mixing was facilitated by raising the temperature slightly (not exceeding 60° C.). Stirring is continued until a homogeneous mixture has been obtained.

### Method 4: OD Preparation

Formulation components (c), carrier (d) active ingredient (a), spreader (b) are weighed in, homogenized with a high-shear device (e.g. Ultraturrax or colloidal mill) and subsequently milled in a bead mill (e.g. Dispermat SL50, 80% filling, 1.0-1.25 mm glass beads, 4000 rpm, circulation grinding) until a particle size of <10μ, is achieved. Alternatively, formulation components are mixed in a bottle followed by addition of approx. 25 vol.-% of 1.0-1.25 mm glass beads. The bottle is then closed, clamped in an agitator apparatus (e.g. Retsch MM301) and treated at 30 Hz for several minutes until a particle size of <10μ is achieved.

### Method 5: Coverage

Greenhouse plants in the development stage as indicated in Tables 1a& 1b were used for these experiments. Single leaves were cut just before the spraying experiment, placed into petri dishes and attached by tape at both tips at 0° (horizontally) or at 60° (so that 50% of leaf area can be sprayed). The leaves were carried with caution to avoid damage of the wax surface. These horizontally orientated leaves were either a) placed into a spay chamber where the spray liquid was applied via a hydraulic nozzle or b) a 4 μl drop of spray liquid was pipetted on top without touching the leaf surface.

A small amount of UV dye was added to the spray liquid to visualize the spray deposits under UV light. The concentration of the dye has been chosen such that it does not influence the surface properties of the spray liquid and does not contribute to spreading itself. Tinopal OB as a colloidal suspension was used for all flowable and solid formulation such as WG, SC, OD and SE. Tinopal CBS-X or Blankophor SOL were used for formulations where active ingredient is dissolved such as EC, EW and SL. The Tinopal CBS-X was dissolved in the aqueous phase and the Blankophor SOL dissolved in the oil phase.

After evaporation of the spray liquid, the leaves were placed into a Camag, Reprostar 3 UV chamber where pictures of spray deposits were taken under visual light and under UV light at 366 nm. A Canon EOS 700D digital camera was attached to the UV chamber and used to acquire images the leaves. Pictures taken under visual light were used to subtract the leaf shape from the background. ImageJ software was used to calculate either a) the percentage coverage of the applied spray for sprayed leaves or b) spread area for pipetted drops in mm².

### Method 6: Insecticide Greenhouse Tests

Selected crops were grown under greenhouse conditions in plastic pots containing “peat soil T”. At appropriate crop stage, plants were prepared for the treatments, e.g. by infestation with target pest approximately 2 days prior to treatment (s. table below).

Spray solutions were prepared with different doses of active ingredient directly by dilution of formulations with tap water and addition of appropriate amount of additives in tank mix, where required.

The application was conducted with a tracksprayer onto the upperside of leaves with 300 l/ha or 10 l/ha application volume. Nozzles used: Lechler's TeeJet TP8003E (for 300 l/ha) and Lechler's 652.246 together with a pulse-width-module (PWM) (for 10 l/ha). For each single dose applied, usually 2 to 5 replicates were simultaneously treated.

After treatment, plants were artificially infested, if needed, and kept during test duration in a greenhouse or climate chamber. The efficacy of the treatments was rated after evaluation of mortality (in general, given in %) and/or plant protection (calculated e.g. from feeding damage in comparison to corresponding controls) at different points of time. Only mean values are reported.

TABLE M1
Pests and crops used in the tests.

| crop | crop stage | infestation | pest | English name | pest life stage | test objective |
|---|---|---|---|---|---|---|
| soybean | BBCH12, | after | Nezara | green stink bug | 10 × nymphs | contact and oral |
| | 5 plants | treatment | viridula | | N2-N3 | uptake |
| | in pot | | | | | |
| cabbage | BBCH12, | prior to | Myzus | green peach | mixed | translaminar |
| | 1-leaf | treatment | persicae | aphid | population | activity |

Selected crops were grown under greenhouse conditions in plastic pots containing “peat soil T”. At appropriate crop stage, plants were prepared for the treatments, e.g. by infestation with target pest approximately 2 days prior to treatment (table M1).

Spray solutions were prepared with different doses of active ingredient directly by dilution of formulations with tap water and addition of appropriate amount of additives in tank mix, where required.

The application was conducted with tracksprayer onto upperside of leaves with 300 l/ha or 10 l/ha application volume. Nozzles used: Lechler's TeeJet TP8003E (for 300 l/ha) and Lechler's 652.246 together with a pulse-width-module (PWM) (for 10 l/ha). For each single dose applied, usually 2 to 5 replicates were simultaneously treated.

After treatment, plants were artificially infested, if needed, and kept during test duration in a greenhouse or climate chamber. The efficacy of the treatments was rated after evaluation of mortality (in general, given in %) and/or plant protection (calculated e.g. from feeding damage in comparison to corresponding controls) at different points of time. Only mean values are reported.

### Method 7: Cuticle Wash-Off

A disc from an apple cuticle was fixed with the outside surface facing upwards to a glass microscope slide with a thin layer of medium viscosity silicone oil. To this 0.9 μl drops of the different formulations diluted at the spray dilution in deionised water containing 5% CIPAC C water were applied with a micropipette and left to dry for 1 hour. Each deposit was examined in an optical transmission microscope fitted with crossed polarising filters and an image recorded. The slide containing the cuticle with the dried droplets of the formulations was held under gently running deionised water (flow rate approximately 300 ml/minute at a height 10 cm below the tap outlet) for 15 s. The glass slide was allowed to dry and the deposits were re-examined in the microscope and compared to the original images. The amount of active ingredient washed off was visually estimated and recorded in steps of 10%. Three replicates were measured and the mean value recorded.

### Method 8: Leaf Wash-Off

Apple or corn leaf sections were attached to a glass microscope slide. To this 0.9 μl drops of the different formulations diluted at the spray dilution in deionised water containing 5% CIPAC C water and a small amount of fluorescent tracer (Tinopal OB as a micron sized aqueous suspension) were applied with a micropipette and left to dry for 1 hour. Under UV illumination (365 nm) the leaf deposits were imaged by a digital camera. The leaf sections were then held under gently running deionised water (flow rate approximately 300 ml/minute at a height 10 cm below the tap outlet) for 15 s. The leaf sections were allowed to dry and the deposits were re-imaged and compared to the original images. The amount of active ingredient washed off was visually estimated between 5 with most remaining and 1 with most removed. Three or more replicates were measured and the mean value recorded.

### Method 9: Suspo-Emulsion Preparation

The method of the preparation of suspo-emulsion formulations are known in the art and can be produced by known methods familiar to those skilled in the art. A 2% gel of the xanthan in water and the biocides (e) was prepared with low shear stirring. The active ingredient spiroxamine (a), oils (b/c) and antioxidant (e) were mixed and added to an aqueous dispersion comprising a portion of the non-ionic dispersants (c) under high shear mixing with a rotor-stator mixer until an oil in water emulsion was formed with a droplet size D(v,0.9) typically 1 to 5 microns. The active ingredient (a), the remaining non-ionic and anionic dispersants (c/e) and other remaining formulants (c/e) were mixed with the remaining water to form a slurry, first mixed with a high shear rotor-stator mixer to reduce the particle size D(v,0.9) to approximately 50 microns, then passed through one or more bead mills to achieve a particles size D(v,0.9) typically 1 to 15 microns as required for the biological performance of the active ingredient(s). Those skilled in the art will appreciate that this can vary for different active ingredients. The oil in water emulsion, polymer dispersion (c/d) and xanthan gel were added and mixed in with low shear stirring until homogeneous.

### Method 10: Description for Herbicide Greenhouse Tests

Seeds of crops and monocotyledonous and dicotyledonous harmful plants are laid out in sandy loam in plastic pots, covered with soil and cultivated in a greenhouse under optimum growth conditions. Two to three weeks after sowing, the test plants are treated at the one- to two-leaf stage. The test herbicide formulations are prepared with different concentrations and sprayed onto the surface of the green parts of the plants using different water application rates: 200 l/ha as a standard conventional rate and 10 l/ha as an ultra-low-volume (ULV) application rate. The nozzle type used for all applications is TeeJet DG 95015 EVS. The ULV application rate is achieved by using a pulse-width-modulation (PWM) system that gets attached to the nozzle and the track sprayer device. After application, the test plants were left to stand in the greenhouse for 3 to 4 weeks under optimum growth conditions. Then, the activity of the herbicide formulation is scored visually (for example: 100% activity=the whole plant material is dead, 0% activity=plants are similar to the non-treated control plants).

TABLE M2
Plant species used in the tests.

| | Abbreviation/ | Crop |
|---|---|---|
| Plant species | EPPO Code | Variety |
| Setaria viridis | SETVI | |
| Echinochloa crus-galli | ECHCG | |
| Alopecurus myosuroides | ALOMY | |
| Hordeum murinum | HORMU | |
| Avena fatua | AVEFA | |
| Lolium rigidum | LOLRI | |
| Matricaria inodora | MATIN | |
| Veronica persica | VERPE | |
| Abutilon theophrasti | ABUTH | |
| Pharbitis purpurea | PHBPU | |
| Polygonum convolvulus | POLCO | |
| Amaranthus retroflexus | AMARE | |
| Stellaria media | STEME | |
| Zea mays | ZEAMA | Aventura |
| Triticum aestivum | TRZAS | Triso |
| Brassica napus | BRSNW | Fontan |

### Method 11: Description for Fungicide Greenhouse Tests

Seeds were laid out in “peat soil T” in plastic pots, covered with soil and cultivated in a greenhouse under optimum growth conditions. Two to three weeks after sowing, the test plants were treated at the one- to two-leaf stage. The test fungicide formulations were prepared with different concentrations and sprayed onto the surface of the plants using different water application rates: 200 l/ha as a standard conventional rate and 10 l/ha as an ultra-low-volume (ULV) application rate. The nozzle type used for all applications was TeeJet TP 8003E, used with 0.7-1.5 bar and 500-600 mm height above plant level. Cereal were put in an 45° angle as this reflected best the spray conditions in the field for cereals. The ULV application rate was achieved by using a pulse-width-modulation (PWM) system attached to the nozzle and the track sprayer device at 30 Hz, opening 8%-100% (10 l/ha-200 l/ha spray volume).

In a protective treatment the test plants were inoculated 1 day after the spray application with the respective disease and left to stand in the greenhouse for 1 to 2 weeks under optimum growth conditions. Then, the activity of the fungicide formulation was assessed visually.

In curative conditions plants were first inoculated with the disease and treated 2 days later with the fungicide formulations. Visual assessment of the disease was done 5 days after application of formulations.

The practices for inoculation are well known to those skilled in the art.

TABLE M3
Diseases and crops used in the tests.

| | | | | Abbreviation/ |
|---|---|---|---|---|
| | | | | EPPO |
| Plant | Crop | | | Code |
| species | Variety | Disease | English Name | disease |
| Soybean | Merlin | Phakopsora | Soybean rust | PHAKPA |
| | | pachyrhizi | | |
| Wheat | Monopol | Puccinia triticina | Brown rust | PUCCRT |
| Barley | Gaulois | Pyrenophora teres | Net blotch | PYRNTE |
| Barley | Villa | Blumeria graminis | Powdery mildew | ERYSGH |
| Tomato | Rentita | Phytophtora | Late blight | PHYTIN |
| | | infestans | | |

### Method 12: Cuticle Penetration Test

The cuticle penetration test is a further developed and adapted version of the test method SOFU (simulation of foliar uptake) originally described by Schonherr and Baur (Schonherr, J., Baur, P. (1996), Effects of temperature, surfactants and other adjuvants on rates of uptake of organic compounds. In: The plant cuticle—an integrated functional approach, 134-155. Kerstiens, G. (ed.), BIOS Scientific publisher, Oxford); it is well suited for systematic and mechanistic studies on the effects of formulations, adjuvants and solvents on the penetration of agrochemicals.

Apple leaf cuticles were isolated from leaves taken from trees growing in an orchard as described by Schönherr and Riederer (Schönherr, J., Riederer, M. (1986), Plant cuticles sorb lipophilic compounds during enzymatic isolation. Plant Cell Environ. 9, 459-466). Only the astomatous cuticular membranes of the upper leaf surface lacking stomatal pores were obtained. Discs having diameters of 18 mm were punched out of the leaves and infiltrated with an enzymatic solution of pectinase and cellulase. The cuticular membranes were separated from the digested leaf cell broth, cleaned by gently washing with water and dried. After storage for about four weeks the permeability of the cuticles reaches a constant level and the cuticular membranes are ready for the use in the penetration test.

The cuticular membranes were applied to diffusion vessels. The correct orientation is important: the inner surface of the cuticle should face to the inner side of the diffusion vessel. A spray was applied in a spray chamber to the outer surface of the cuticle. The diffusion vessel was turned around and carefully filled with acceptor solution. Aqueous mixture buffered to pH 5.5 was used as acceptor medium to simulate the apoplast as natural desorption medium at the inner surface of the cuticle.

The diffusion vessels filled with acceptor and stirrer were transferred to a temperature-controlled stainless steel block which ensures not only a well-defined temperature but also a constant humidity at the cuticle surface with the spray deposit. The temperature at the beginning of experiments was 25° C. or 30° C. and changes to 35° 24 h after application at constantly 60% relative humidity.

An autosampler took aliquots of the acceptor in regular intervals and the content of active ingredient is determined by HPLC (DAD or MS). All data points were finally processed to obtain a penetration kinetic. As the variation in the penetration barrier of the cuticles is high, five to ten repetitions of each penetration kinetic were made.

### Materials

TABLE MAT1
Exemplified trade names and CAS-No's of preferred super-spreading compounds (b)

| Product | Chemical name | Cas No. | Supplier |
|---|---|---|---|
| Geropon ® | Dioctylsulfosuccinate sodium | 577-11-7 | Rhodia |
| DOS-PG | salt (65-70% in propylene glycol) | | |
| Synergel ® | Dioctylsulfosuccinate sodium | 577-11-7 | Clariant |
| W 10 | salt (65-70% in propylene glycol) | | |
| Aerosol ® | Dioctylsulfosuccinate sodium | 577-11-7 | Cytec |
| OT 70 PG | salt (65-70% in propylene glycol) | | |
| Lankropol KPH70 | Dioctylsulfosuccinate sodium | 577-11-7 | Nouryon |
| | salt (65-70% in propylene glycol) | | |
| Enviomet EM | Dioctylsulfosuccinate sodium | 577-11-7 | Innospec |
| 5669 | salt (65-70% in propylene glycol) | | |
| Surfynol ® S420 | 2,4,7,9-Tetramethyl-5-Decyne- | 9014-85-1 | Evonik |
| | 4,7-Diol ethoxylate (1 mole) | | |
| Surfynol ® S440 | 2,4,7,9-Tetramethyl-5-Decyne- | 9014-85-1 | Evonik |
| | 4,7-Diol ethoxylate (3.5 moles) | | |
| Surfynol ® S465 | 2,4,7,9-Tetramethyl-5-Decyne- | 9014-85-1 | Evonik |
| | 4,7-Diol ethoxylate (10 moles) | | |
| Surfynol ® S485 | 2,4,7,9-Tetramethyl-5-Decyne- | 9014-85-1 | Evonik |
| | 4,7-Diol ethoxylate (30 moles) | | |
| Break-Thru ® | Not disclosed | | Evonik |
| Vibrant | | | |
| Genapol ® EP | C10-12 alcohol alkoxylate | | Clariant |
| 0244 | (PO + EO) | | |
| Synergen ® W06 | C11 alcohol alkoxylate (PO + EO) | | Clariant |
| Genapol ® EP | C12-15 alcohol alkoxylate | | Clariant |
| 2584 | (PO + EO) | | |
| Agnique ® | Oligomeric D-glucopyranose | 68515-73-1 | BASF |
| PG8107 | decyl octyl glycosides | | |
| Silwet ® L77 | 3-(2-methoxyethoxy)propyl- | 27306-78-1 | Momentive |
| | methyl-bis | | |
| | (trimethylsilyloxy)silane | | |
| Silwet ® 408 | 2-[3- | 67674-67-3 | Momentive |
| | [[dimethyl(trimethylsilyloxy) | | |
| | silyl]oxy-methyl- | | |
| | trimethylsilyloxysilyl]propoxy] | | |
| | ethanol | | |
| Silwet ® 806 | 3-[methyl- | 134180-76-0 | Momentive |
| | bis(trimethylsilyloxy)silyl]propan- | | |
| | 1-ol; 2-methyloxirane;oxirane | | |
| Break-thru ® S240 | 3-[methyl-bis | 134180-76-0 | Evonik |
| | (trimethylsilyloxy)silyl]propan- | | |
| | 1-ol;2-methyloxirane;oxirane | | |
| Break-thru ® S278 | 3-(2-methoxyethoxy) | 27306-78-1 | Evonik |
| | propyl-methyl- | | |
| | bis(trimethylsilyloxy)silane | | |
| Silwet ® HS 312 | | | |
| Silwet ® HS 604 | | | |
| BreakThru ® OE | Siloxanes and Silicones, cetyl | 191044-49-2 | Evonik |
| 444 | Me, di-Me | | |

TABLE MAT2
Exemplified trade names and CAS-No's of
preferred uptake enhancing compounds (b)

| Product | Chemical name | Cas No. | Supplier |
|---|---|---|---|
| Emulsogen ® EL 400 | Ethoxylated Castor Oil | 61791-12-6 | Clariant |
| | with 40 EO | | |
| ETOCAS ® 10 | Ethoxylated Castor | 61791-12-6 | Croda |
| | Oil with 10 EO | | |
| Crovol ® CR70G | fats and glyceridic oils, | 70377-91-2 | Croda |
| | vegetable, ethoxylated | | |
| Synperonic ® A3 | alcohol ethoxylate | 68131-39-5 | Croda |
| | (C12/C15-EO3) | | |
| Synperonic ® A7 | alcohol ethoxylate | 68131-39-5 | Croda |
| | (C12/C15-EO7) | | |
| Genapol ® X060 | alcohol ethoxylate | 9043-30-5 | Clariant |
| | (iso-C13-EO6) | | |
| Alkamuls ® A | Oleic acid, ethoxylated | 9004-96-0 | Solvay |
| Lucramul ® HOT | alcohol ethoxylate-propoxylate | 64366-70-7 | Levaco |
| 5902 | (C8-PO8/EO6) | | |
| Antarox B/848 | Butyl alcohol | 9038-95-3 | Solvay |
| | propoxylate/ethoxylate | | |
| Tween ® 80 | Sorbitan monooleate, | 9005-65-6 | Croda |
| | ethoxylated (20EO) | | |
| Tween ® 85 | Sorbitan trioleate, | 9005-70-3 | Croda |
| | ethoxylated (20EO) | | |
| Tween ® 20 | Sorbitan monolaurate, | 9005-64-5 | Croda |
| | ethoxylated (20EO) | | |
| Sunflower oil | Triglycerides from different | 8001-21-6 | |
| | C14-C18 fatty acids, | | |
| | predominantly unsaturated | | |
| Rapeseed oil | Triglycerides from different | 8002-13-9 | |
| | C14-C18 fatty acids, | | |
| | predominantly | | |
| | unsaturated | | |
| Corn oil | Triglycerides from different | 8001-30-7 | |
| | C14-C18 fatty acids, | | |
| | predominantly unsaturated | | |
| Soybean oil | Triglycerides from different | 8001-22-7 | |
| | C14-C18 fatty acids, | | |
| | predominantly unsaturated | | |
| Rice bran oil | Triglycerides from different | 68553-81-1 | |
| | C14-C18 fatty acids, | | |
| | predominantly unsaturated | | |
| Radia ® 7129 | ethylhexyl palmitate | 29806-73-3 | Oleon NV, BE |
| Crodamol ® OP | | | Croda, UK |
| Radia ® 7331 | ethylhexyl oleate | 26399-02-0 | Oleon NV, BE |
| Radia ® 7128 | ethylhexyl myristate/ | 29806-75-5 | Oleon NV, BE |
| | laurate C12/C14 | | |
| Radia ® 7127 | ethylhexyl laurate | 20292-08-4 | Oleon NV, BE |
| Radia ® 7126 | ethylhexyl caprylate/ | 63321-70-0 | Oleon NV, BE |
| | caprate C8/10 | | |
| Estol ® 1514 | iso-propyl myristate | 110-27-0 | Croda |
| Radia ® 7104 | Caprylic, capric | 73398-61-5. | Oleon NV, BE |
| | triglycerides, | 65381-09-1 | |
| | neutral vegetable oil | | |

TABLE MAT3
Exemplified trade names of preferred wash-off reducing materials (d)

| Product | Chemical name | Tg | MFFT | Supplier |
|---|---|---|---|---|
| Atplus ® FA | Aqueous styrene acrylic | <30° C. | | Croda |
| | co-polymer emulsion | | | |
| | dispersion | | | |
| Acronal ® V215 | aqueous acrylate | −43° C. | | BASF |
| Acronal ® V115 | co-polymer dispersion | −58° C. | | |
| Acronal ® A245 | containing carboxylic | −45° C. | | |
| Acronal ® A240 | groups. | −30° C. | | |
| Acronal ® A225 | | −45° C. | | |
| Acronal ® A145 | | −45° C. | | |
| Acronal ® 500 D | aqueous acrylic co- | −13° C. | | BASF |
| Acronal ® S 201 | polymer dispersion | −25° C. | | |
| Acronal ® DS 3618 | aqueous acrylic ester | −40° C. | | BASF |
| Acronal ® 3612 | co-polymer dispersion | +12° C. | | |
| Acronal ® V 212 | | −40° C. | | |
| Acronal ® DS 3502 | | +4° C. | | |
| Acronal ® S 400 | | −8° C. | | |
| Licomer ® ADH205 | aqueous acrylic | <30° C. | | Michelman |
| Licomer ® ADH203 | ester co-polymer | | | |
| | dispersion containing | | | |
| | carboxylic groups. | | | |
| Primal ® CM-160 | Aqueous acrylic | | | DOW |
| Primal ® CM-330 | copolymer | | | |
| | emulsion polymer | | | |
| Axilat ® | Aqueous acrylic | −15° C. | 0° C. | Synthomer |
| UltraGreen 5500 | emulsion polymer | | | |
| Povol ® 26/88 | Polyvinyl alcohol | | | Kuraray |

Table MAT4: Exemplified Trade Names and CAS-No's of Preferred Compounds (e)

TABLE I1
Exemplified trade names and CAS-No's of
preferred compounds (e) for Insecticide Examples

| Product | Chemical name | Cas No. | Supplier |
|---|---|---|---|
| Lucramul PS 29 | Poly(oxy-1,2-ethanediyl),. | 104376-75-2 | Levaco |
| | alpha.-phenyl-. | | |
| | omega.-hydroxy-, | | |
| | styrenated | | |
| Atlox ® 4913 | methyl methacrylate graft | 119724-54-8 | Croda |
| | copolymer with polyethylene | | |
| | glycol | | |
| Morwet IP | Naphthalenesulfonic acid, | 68909-82-0 | Akzo Nobel |
| | bis(1-methylethyl)-, Me derivs., | | |
| | sodium salts | | |
| Synperonic ® | block-copolymer of polyethylene | 9003-11-6 | Croda |
| PE/F127 | oxide and polypropylene oxide | | |
| Morwet D425 | Sodium naphthalene sulphonate | 577773-56-9 | Akzo Nobel, |
| | formaldehyde condensate | 68425-94-5 | Nouryon |
| | | 9008-63-3 | |
| ATLAS ® | Oxirane, methyl-, polymer | 9038-95-3 | Croda |
| G 5000 | with oxirane, monobutyl ether | | |
| Glycerin | | 56-81-5 | |
| Propylene | 1,2-Propylene glycol | 57-55-6 | |
| Glycol | | | |
| RHODOPOL ® | Polysaccharide | 11138-66-2 | Solvay |
| 23 | | | |
| Sipernat 22 S | synthetic amorphous silica | 112926-00-8 | Evonik |
| | (silicon dioxide) | 7631-86-9 | |
| Veegum R | Smectite-group minerals | 12199-37-0 | |
| SILCOLAPSE ® | Polydimethylsiloxanes | 9016-00-6 | BLUESTAR |
| 426R | and silica | | SILICONES |
| SAG ® 1572 | Dimethyl siloxanes and | 63148-62-9 | Momentive |
| | silicones | | |
| Citric Acid | | 77-92-9 (anhydrous); | |
| | | 5949-29-1 | |
| | | (Monohydrate) | |
| Proxel ® GXL | 1.2-benzisothiazol-3(2H)-one | 2634-33-5 | Arch |
| Kathon ® | 5-chloro-2-methyl-4-isothiazolin- | 26172-55-4 plus | Chemicals |
| CG/ICP | 3-one plus 2-methyl-4- | 2682-20-4 | Dow |
| | isothiazolin-3-one | | |

TABLE MAT5
Exemplified trade names and CAS-No's of preferred compounds (e)

| Product | Chemical name | Cas No. | Supplier |
|---|---|---|---|
| Morwet ® D425 | Naphthalene sulphonate | 9008-63-3 | New XX |
| | formaldehyde condensate Na salt | | |
| Synperonic ® | block-copolymer of polyethylene | 9003-11-6 | Croda |
| PE/F127 | oxide and polypropylene oxide | | |
| Synperonic® A7 | alcohol ethoxylate (C12/C15-EO7) | 68131-39-5 | Croda |
| Xanthan | Polysaccharide | 11138-66-2 | |
| Proxel ® GXL | 1.2-benzisothiazol-3(2H)-one | 2634-33-5 | Arch Chemicals |
| Kathon ® CG/ICP | 5-chloro-2-methyl-4-isothiazolin- | 26172-55-4 | Dow |
| | 3-one plus 2-methyl-4- | plus | |
| | isothiazolin-3-one | 2682-20-4 | |
| Propylene glycol | 1,2-Propylene glycol | 57-55-6 | |
| SAG ® 1572 | Dimethyl siloxanes and silicones | 63148-62-9 | Momentive |
| Atlox ® 4913 | methyl methacrylate graft | 119724-54-8 | Croda |
| | copolymer with polyethylene glycol | | |
| ATLAS ® G 5000 | Oxirane, methyl-, polymer with | 9038-95-3 | Croda |
| | oxirane, monobutyl ether | | |
| SILCOLAPSE ® 454 | Polydimethylsiloxanes and silica | 9016-00-6 | BLUESTAR |
| | | | SILICONES |
| RHODOPOL ® 23 | Polysaccharide | 11138-66-2 | Solvay |
| ACTICIDE ® MBS | Mixture of 2-methy1-4-isothiazolin- | 2682-20-4 | Thor GmbH |
| | 3-one (MIT) and 1,2- | 2634-33-5 | |
| | benzisothiazolin-3-one (BIT) in | | |
| | water | | |
| Sokalan ® K 30 | Polyvinylpyrrolidone | 9003-39-8 | BASF |
| Supragil ® WP | Sodium diisopropyl naphthalene | 1322-93-6 | Solvay |
| | sulfonate | | |
| Morwet ® D-425 | Sodium naphthalene sulphonate | 577773-56-9 | Akzo Nobel, |
| | formaldehyde condensate | 68425-94-5 | Nouryon |
| | | 9008-63-3 | |
| Soprophor ® | Tristyrylphenol ethoxylate sulfate | 119432-41-6 | Solvay |
| 4 D 384 | (16 EO) ammonium salt | | |
| Rhodorsil ® Antim | absorbed polydimethyl siloxane | unknown | Solvay |
| EP 6703 | antifoam | | |
| Kaolin Tec 1 | Aluminiumhydrosilicate | 1318-74-7 | Ziegler & Co. |
| | | 1332-58-7 | GmbH |
| Sipernat ® 22 S | synthetic amorphous silica | 112926-00-8 | Evonik |
| | (silicon dioxide) | 7631-86-9 | |
| RHODACAL ® | Calcium- | 26264-06-2 | Solvay |
| 60 BE | dodecylbenzenesulphonate in | 104-76-7 | |
| | 2-Ethylhexanol | | |
| Emulsogen ® | Ethoxylated Castor Oil | 61791-12-6 | Clariant |
| EL 400 | with 40 EO | | |
| Solvesso ® 200ND | Mixture of aromatic hydrocarbons | 64742-94-5 | ExxonMobil |
| | (C9-C11), naphtalene depleted | | |

### FUNGICIDES EXAMPLES

### Example FN1: Isoflucypram SC

TABLE FN1
Recipes FN1, FN2 and FN3.

| | | | Recipe | Recipe |
|---|---|---|---|---|
| | | | FN2 | FN3 |
| | | Recipe | according | according |
| | | FN1 | to the | to the |
| Component (g/l) | | reference | invention | invention |
| Isoflucypram | (a) | 50.0 | 50.0 | 50.0 |
| Morwet ® D425 | (c) | 5.0 | 5.0 | 5.0 |
| Synperonic ® | (c) | 12.0 | 12.0 | 12.0 |
| PE/F127 | | | | |
| Etocas ® 10-LQ | (b) | 0.0 | 50.0 | 0.0 |
| Lucramol ® | (b) | 0.0 | 0.0 | 50.0 |
| HOT5902 | | | | |
| Xanthan | (c) | 3.0 | 3.0 | 3.0 |
| Proxel ® GXL | (c) | 1.8 | 1.8 | 1.8 |
| Kathon ® CG/ICP | (c) | 0.8 | 0.8 | 0.8 |
| Propylene glycol | (c) | 80.0 | 80.0 | 80.0 |
| SAG ® 1572 | (c) | 6.0 | 6.0 | 6.0 |
| Water (add | (c) | To volume | To volume | To volume |
| to 1 litre) | | (~862) | (~812) | (~812) |

The method of preparation used was according to Method 1.

### Cuticle Penetration

The penetration through apple leaf cuticles was determined according to cuticle penetration test method 12.

TABLE FN2
Cuticle penetration for isoflucypram SC formulations.

| | | | | Uptake |
|---|---|---|---|---|
| | | | | enhancing |
| | | | Uptake | surfactant |
| | | | enhancing | dose |
| | | | surfactant | in spray |
| | Penetration | Penetration | dose | liquid |
| Recipe | % 24 h | % 61 h | g/ha | % w/v |
| Recipe FN1 not according | 3.1 | 33.2 | 0 | 0 |
| to the invention-10 l/ha | | | | |
| Recipe FN1 not according | 4.4 | 29.6 | 0 | 0 |
| to the invention-200 l/ha | | | | |
| Recipe FN2 according to | 6.8 | 80.8 | 50 | 0.5 |
| the invention-10 l/ha | | | | |
| Recipe FN 2according to | 10.3 | 90.5 | 50 | 0.025 |
| the invention-200 l/ha | | | | |
| Recipe FN3 according to | 7.9 | 70.9 | 50 | 0.5 |
| the invention-10 l/ha | | | | |
| Recipe FN3 according to | 7.3 | 56.6 | 50 | 0.025 |
| the invention-200 1/ha | | | | |

Formulations tested at 1.0 /ha.

The recipe FN3 illustrative of the invention shows higher penetration of the active ingredient at 10 l/h than at 200 l/ha. The recipe FN2 illustrative of the invention shows high penetration at both 10 l/ha and 200 l/ha, with 200 l/ha a little greater. Both FN3 and FN2 show significantly greater penetration than the reference FN1 at both 10 l/ha and 200 l/ha.

### Example FN2: Isoflucypram SC

TABLE FN3
Recipes FN4 and FN5.

| | | | Recipe |
|---|---|---|---|
| | | | FN5 |
| | | Recipe | according |
| | | FN4 | to the |
| Component (g/l) | | reference | invention |
| Isoflucypram | (a) | 50.0 | 50.0 |
| Morwet ® D425 | (c) | 1.0 | 1.0 |
| Synperonic ® PE/F127 | (c) | 5.0 | 5.0 |
| Crovol ® CR70G | (b) | 0.0 | 100.0 |
| Xanthan | (c) | 3.6 | 3.6 |
| Proxel ® GXL | (c) | 1.8 | 1.8 |
| Kathon ® CG/ICP | (c) | 0.8 | 0.8 |
| Propylene glycol | (c) | 60.0 | 60.0 |
| SAG ® 1572 | (c) | 6.0 | 6.0 |
| Water (add to | (c) | To volume | To volume |
| 1 litre) | | (~917) | (~817) |

The method of preparation used was according to Method 1.

### Greenhouse

### Efficacy Data

TABLE FN4
Biological efficacy on PYRNTE

| | | | | Recipe FN5 |
|---|---|---|---|---|
| | | | Recipe | according |
| | Rate | | FN4 | to the |
| Spray | of SC | Rate | reference | invention |
| volume | applied | of a.i. | Efficacy | Efficacy |
| l/ha | l/ha | g/ha | [%] | [%] |
| 200 | 0.5 | 25 | 97 | 100 |
| 200 | 0.1 | 5 | 43 | 100 |
| 200 | 0.05 | 2.5 | 29 | 97 |
| 10 | 0.5 | 25 | 93 | 100 |
| 10 | 0.1 | 5 | 71 | 100 |
| 10 | 0.05 | 2.5 | 71 | 100 |

Method 11: wheat, protective 1 day before inoculation evaluation 10 DAT
The results show that recipe FNS shows higher efficacy at both 200 l/ha and 10 l/ha spray volumes than the reference recipe FN4 without the uptake enhancing additive (b).

### Example FN3: Tebuconazole 20 SC

TABLE FN5
Recipes FN6 and FN7.

| | | | Recipe |
|---|---|---|---|
| | | | FN7 |
| | | Recipe | according |
| | | FN6 | to the |
| Component (g/l) | | reference | invention |
| Tebuconazole | (a) | 20.0 | 20.0 |
| Morwet ® D425 | (c) | 2.0 | 2.0 |
| Synperonic ® PE/F127 | (c) | 5.0 | 5.0 |
| Crovol ® CR70G | (b) | 0.0 | 100 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 2.0 | 2.0 |
| Na₂HPO₄ | (c) | 1.5 | 1.5 |
| (Buffer solution pH = 7 ) | | | |
| Na₂HPO₄ | (c) | 0.8 | 0.8 |
| (Buffer solution pH = 7) | | | |
| Water (add to 1 litre) | (c) | To volume | To volume |
| | | (~913) | (~773) |

The method of preparation used was according to Method 1.

### Greenhouse

### Efficacy Data

TABLE FN6
Biological efficacy on PHAKPA

| | | | | Recipe |
|---|---|---|---|---|
| | | | | FN7 |
| | | | Recipe | according |
| | Rate | | FN6 | to the |
| Spray | of SC | Rate | reference | invention |
| volume | applied | of a.i. | Efficacy | Efficacy |
| l/ha | l/ha | g/ha | [%] | [%] |
| 200 | 0.25 | 5 | 99 | 100 |
| 200 | 0.05 | 1 | 53 | 79 |
| 200 | 0.025 | 0.5 | 25 | 19 |
| 10 | 0.25 | 5 | 100 | 100 |
| 10 | 0.05 | 1 | 86 | 100 |
| 10 | 0.025 | 0.5 | 55 | 81 |

Method 11: soybean, 1 day protective, evaluation 7 dat

The results show that recipe FN7 illustrative of the invention shows higher efficacy at 10 l/ha spray volume than 200 l/ha. Furthermore, recipe Y shows higher efficacy at both 200 l/ha and 10 l/ha spray volumes than the reference recipe FN6 without the uptake enhancing additive (b).

### Greenhouse

TABLE FN7
Biological efficacy on PHAKPA

| | | | | Recipe |
|---|---|---|---|---|
| | | | | FN7 |
| | | | Recipe | according |
| | Rate | | FN6 | to the |
| Spray | of SC | Rate | reference | invention |
| volume | applied | of a.i. | Efficacy | Efficacy |
| l/ha | l/ha | g/ha | [%] | [%] |
| 200 | 0.5 | 10 | 100 | 100 |
| 200 | 0 | 5 | 62 | 100 |
| 200 | 0.05 | 1 | 35 | 6 |
| 10 | 0.5 | 10 | 96 | 100 |
| 10 | 0.1 | 5 | 69 | 100 |
| 10 | 0.05 | 1 | 46 | 77 |

Method 11: soybean, 1 day protective, evaluation 7 dat

The results show that recipe FN7 illustrative of the invention shows higher efficacy at 10 l/ha spray volume than 200 l/ha. Furthermore, recipe FN7 shows higher efficacy at both 200 l/ha and 10 l/ha spray volumes than the reference recipe FN6 without the uptake enhancing additive (b).

### Example FN4: Bixafen 20 SC

TABLE FN8
Recipes FN8 and FN9.

| | | | Recipe |
|---|---|---|---|
| | | | FN9 |
| | | Recipe | according |
| Component | | FN8 | to the |
| (g/l) | | reference | invention |
| Bixafen | (a) | 20.0 | 20.0 |
| Morwet ® D425 | (c) | 2.0 | 2.0 |
| Synperonic ® PE/F127 | (c) | 5.0 | 5.0 |
| Crovol ® CR70G | (b) | 0.0 | 140 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 2.0 | 2.0 |
| Na₂HPO₄ (Buffer | (c) | 1.5 | 1.5 |
| solution pH = 7) | | | |
| Na₂HPO₄ (Buffer | (c) | 0.8 | 0.8 |
| solution pH = 7) | | | |
| Water | (c) | To volume | To volume |
| (add to 1 litre) | | (~913) | (~773) |

The method of preparation used was according to Method 1.

### Greenhouse

TABLE FN9
Biological efficacy on ERYSGH

| | | | | Recipe FN9 |
|---|---|---|---|---|
| Spray | | | Recipe FN8 | according to |
| volume | Rate of SC | Rate of | reference | the invention |
| l/ha | applied l/ha | a.i. g/ha | Efficacy [%] | Efficacy [%] |
| 200 | 5 | 100 | 50 | 100 |
| 200 | 2.5 | 50 | 17 | 100 |
| 200 | 1.25 | 25 | 0 | 100 |
| 200 | 0.5 | 10 | 17 | 33 |
| 10 | 5 | 100 | 17 | 67 |
| 10 | 2.5 | 50 | 0 | 67 |
| 10 | 1.25 | 25 | 0 | 67 |
| 10 | 0.5 | 10 | 0 | 50 |

Method 11: barley, 1 day protective, evaluation 7 dat

The results show that recipe FN9 illustrative of the invention shows higher efficacy at both 200 l/ha and 10 l/ha spray volumes than the reference recipe FN8 without the uptake enhancing additive (b).

### Example FN5: Prothioconazole 20 SC

TABLE FN10
Recipes FN10 and FN11.

| | | Recipe | Recipe FN11 |
|---|---|---|---|
| | | FN10 | according to |
| Component (g/l) | | reference | the invention |
| Prothioconazole | (a) | 20.0 | 20.0 |
| Morwet ® D425 | (c) | 2.0 | 2.0 |
| Synperonic ® PE/F127 | (c) | 5.0 | 5.0 |
| Crovol ® CR7OG | (b) | 0.0 | 100 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 2.0 | 2.0 |
| Na₂HPO₄ (Buffer | (c) | 1.5 | 1.5 |
| solution pH = 7) | | | |
| NaH₂PO₄ (Buffer | (c) | 0.8 | 0.8 |
| solution pH = 7) | | | |
| Water (add to 1 litre) | (c) | To volume | To volume |
| | | (~913) | (~813) |

The method of preparation used was according to Method 1.

### Greenhouse

TABLE FN11
Biological efficacy on PUCCRT

| | | | | Recipe FN11 |
|---|---|---|---|---|
| Spray | | | Recipe FN10 | according to |
| volume | Rate of SC | Rate of | reference | the invention |
| l/ha | applied l/ha | a.i. g/ha | Efficacy [%] | Efficacy [%] |
| 200 | 5 | 100 | 78 | 100 |
| 200 | 2.5 | 50 | 33 | 89 |
| 200 | 1.25 | 25 | 22 | 78 |
| 10 | 5 | 100 | 94 | 100 |
| 10 | 2.5 | 50 | 67 | 100 |
| 10 | 1.25 | 25 | 22 | 94 |

Method 11: wheat, 1 day protective, evaluation 9 DAT

The results show that recipe FN11 illustrative of the invention shows higher efficacy at 10 l/ha spray volume than 200 l/ha. Furthermore, recipe FN11 shows higher efficacy at both 200 l/ha and 10 l/ha spray volumes than the reference recipe FN10 without the uptake enhancing additive (b).

TABLE FN12
Biological efficacy on PHAKPA

| | | | | Recipe FN11 |
|---|---|---|---|---|
| Spray | | | Recipe FN10 | according to |
| volume | Rate of SC | Rate of | reference | the invention |
| l/ha | applied l/ha | a.i. g/ha | Efficacy [%] | Efficacy [%] |
| 200 | 0.25 | 5 | 98 | 100 |
| 200 | 0.05 | 1 | 94 | 99 |
| 200 | 0.025 | 0.5 | 95 | 95 |
| 200 | 0.005 | 0.1 | 58 | 73 |
| 10 | 0.25 | 5 | 100 | 100 |
| 10 | 0.05 | 1 | 98 | 100 |
| 10 | 0.025 | 0.5 | 89 | 98 |
| 10 | 0.005 | 0.1 | 46 | 92 |

Method 11: soybean, 2 days curative, evaluation 7 days after infestation

The results show that recipe FN11 illustrative of the invention shows higher efficacy at 10 l/ha spray volume than 200 l/ha. Furthermore, recipe FN11 shows higher efficacy at both 200 l/ha and 10 l/ha spray volumes than the reference recipe FN10 without the uptake enhancing additive (b).

### Example FN6: Fluoxapiprolin 5 SC

TABLE FN13
Recipes FN12 and FN13.

| | | | Recipe |
|---|---|---|---|
| | | | FN13 |
| | | Recipe | according |
| | | FN12 | to the |
| Component (g/l) | | reference | invention |
| Fluoxapiprolin | (a) | 5.0 | 5.0 |
| Morwet ® D425 | (c) | 1.0 | 1.0 |
| Synperonic ® PE/F127 | (c) | 5.0 | 5.0 |
| Crovol ® CR70G | (b) | 0.0 | 100.0 |
| Xanthan | (c) | 3.6 | 3.6 |
| Proxel ® GXL | (c) | 1.5 | 1.5 |
| Kathon ® CG/ICP | (c) | 0.8 | 0.8 |
| Propylene glycol | (c) | 50.0 | 50.0 |
| SAG ® 1572 | (c) | 4.0 | 4.0 |
| Water (add to 1 litre) | (c) | To volume | To volume |
| | | (~930) | (~830) |

The method of preparation used was according to Method 1.

### Greenhouse

TABLE FN14
Biological efficacy on PHYTIN

| | | | | Recipe FN13 |
|---|---|---|---|---|
| Spray | | | Recipe FN12 | according to |
| volume | Rate of SC | Rate of | reference | the invention |
| l/ha | applied l/ha | a.i. g/ha | Efficacy [%] | Efficacy [%] |
| 200 | 0.5 | 2.5 | 83 | 96 |
| 200 | 0.2 | 1 | 59 | 95 |
| 200 | 0.1 | 0.5 | 61 | 91 |
| 10 | 0.5 | 2.5 | 54 | 81 |
| 10 | 0.2 | 1 | 37 | 69 |
| 10 | 0.1 | 0.5 | 24 | 53 |

Method 11: tomato, 1 day preventive, evaluation 7 days after infestation

Recipe FN13 shows higher efficacy at both 200 l/ha and 10 l/ha spray volumes than the reference recipe FN12 without the uptake enhancing additive (b).

### Example FN7: Trifloxystrobin 20 SC

TABLE FN15
Recipes X and Y.

| | | Recipe | Recipe FN15 |
|---|---|---|---|
| | | FN14 | according to |
| Component (g/l) | | reference | the invention |
| Trifloxystrobin | (a) | 20 | 20 |
| Morwet ® D425 | (c) | 2 | 2 |
| Synperonic ® PE/F127 | (c) | 5 | 5 |
| Crovol ® CR70G | (b) | 140 | |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60 | 60 |
| SAG ® 1572 | (c) | 2 | 2 |
| Na₂HPO₄ (Buffer | (c) | 1.5 | 1.5 |
| solution pH = 7) | | | |
| NaH₂PO₄ (Buffer | (c) | 0.8 | 0.8 |
| solution pH = 7) | | | |
| Water (add to 1 litre) | (c) | To volume | To volume |
| | | (~913) | (~773) |

The method of preparation used was according to Method 1.

### Greenhouse

TABLE FN17
Biological efficacy on PHAKPA

| | | | Recipe | Recipe FN15 |
|---|---|---|---|---|
| Spray | | | FN14 | according to |
| volume | Rate of SC | Rate of | reference | the invention |
| l/ha | applied l/ha | a.i. g/ha | Efficacy [%] | Efficacy [%] |
| 200 | 0.5 | 10 | 71 | 94 |
| 200 | 0.1 | 5 | 27 | 84 |
| 200 | 0.05 | 1 | 10 | 56 |
| 10 | 0.5 | 10 | 79 | 98 |
| 10 | 0.1 | 5 | 38 | 83 |
| 10 | 0.05 | 1 | 25 | 73 |

Method 11: soybean, 1 day protective, evaluation 7 dat

The results show that recipe FN15 illustrative of the invention shows higher efficacy at both 200 l/ha and 10 l/ha spray volumes than the reference recipe FN14 without the uptake enhancing additive (b).

### Example FNB: Inpyrfluxam 100 SC

TABLE FN18
Recipes FN16 and FN17.

| | | Recipe | Recipe FN17 |
|---|---|---|---|
| | | FN16 | according to |
| Component (g/l) | | reference | the invention |
| Inpyrfluxam | (a) | 100.0 | 100.0 |
| Morwet ® D425 | (c) | 5.0 | 5.0 |
| Atlox ® 4913 | (c) | 10.0 | 10.0 |
| Synperonic ® PE/F127 | (c) | 5.0 | 5.0 |
| Alkamuls ® A | (b) | 0.0 | 80.0 |
| Xanthan | (c) | 3.6 | 3.6 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 6.0 | 6.0 |
| Na₂HPO₄ (Buffer | (c) | 1.5 | 1.5 |
| solution pH = 7) | | | |
| NaH₂PO₄ (Buffer | (c) | 0.8 | 0.8 |
| solution pH = 7) | | | |
| Water (add to 1 litre) | (c) | To volume | To volume |
| | | (~866) | (~765) |

The method of preparation used was according to Method 1.

### Penetration Tests

The penetration through apple leaf cuticles was determined according to cuticle penetration test method 12.

TABLE FN19
Cuticle penetration for inpyrfluxam SC formulations.

| | | | Uptake | Uptake |
|---|---|---|---|---|
| | | | enhancing | enhancing |
| | | | surfactant | surfactant dose |
| | Penetration | Penetration | dose | in spray liquid |
| Recipe | 24 h | 48 h | g/ha | % w/v |
| Recipe FN16 not | 17.0 | 46.9 | 0 | 0 |
| according to the | | | | |
| invention-10 l/ha | | | | |
| Recipe FN16 not | 24.0 | 50.7 | 0 | 0 |
| according to the | | | | |
| invention-200 l/ha | | | | |
| Recipe FN17 | 73.7 | 97.3 | 40 | 0.4 |
| according to the | | | | |
| invention-10 l/ha | | | | |
| Recipe FN17 | 36.6 | 57.8 | 40 | 0.02 |
| according to the | | | | |
| invention-200 l/ha | | | | |

Formulations tested at 0.5 l/ha.

The results show that recipe FN17 illustrative of the invention has a higher cuticle penetration at 10 l/ha than at 200 l/ha, and also greater than the reference recipe FN16 at both 10 l/ha and 200 l/ha.

### Example FN9: Fungicide Isoflucypram 50 SC

TABLE FN20
Recipes FN18, FN19, FN20 and FN21.

| | | | Recipe | | Recipe |
|---|---|---|---|---|---|
| | | | FN19 | | FN21 |
| | | Recipe | according | Recipe | according |
| | | FN18 | to the | FN20 | to the |
| Component (g/l) | | reference | invention | reference | invention |
| Isoflucypram | (a) | 50.0 | 50.0 | 50.0 | 50.0 |
| Morwet ® D425 | (c) | 5.0 | 5.0 | 5.0 | 5.0 |
| Synperonic ® | (c) | 12.0 | 12.0 | 17.0 | 17.0 |
| PE/F127 | | | | | |
| Crodamol ® OP | (b) | 0.0 | 50 | 0.0 | 0.0 |
| Crodamol ® PC | (b) | 0.0 | 0.0 | 50 | 0.0 |
| DAB | | | | | |
| Exxsol ® D80 | (b) | 0.0 | 0.0 | 0.0 | 50 |
| Xanthan | (c) | 3.0 | 3.0 | 3.0 | 3.0 |
| Proxel ® GXL | (c) | 1.5 | 1.5 | 1.5 | 1.5 |
| Kathon ® CG/ICP | (c) | 0.8 | 0.8 | 0.8 | 0.8 |
| Propylene glycol | (c) | 80.0 | 80.0 | 80.0 | 80.0 |
| SAG ® 1572 | (c) | 6.0 | 6.0 | 6.0 | 6.0 |
| Water (add to 1 litre) | (c) | To volume | To volume | To volume | To volume |
| | | (~862) | (~807) | (~806) | (~806) |

The method of preparation used was according to Method 1.

### Penetration Tests

The penetration through apple leaf cuticles was determined according to method 12.

TABLE FN21
Cuticle penetration for isoflucypram SC formulations.

| | | | | Uptake |
|---|---|---|---|---|
| | | | Uptake | enhancing |
| | | | enhancing | surfactant |
| | Penetration | Penetration | surfactant | dose in spray |
| Recipe | 24 h | 61 h | dose g/ha | liquid % w/v |
| Recipe FN18 not | 3.1 | 33.2 | 0 | 0 |
| according to the | | | | |
| invention-10 l/ha | | | | |
| Recipe FN18 not | 4.4 | 29.6 | 0 | 0 |
| according to the | | | | |
| invention-200 l/ha | | | | |
| Recipe FN19 | 6.8 | 61.8 | 50 | 0.5 |
| according to the | | | | |
| invention-10 l/ha | | | | |
| Recipe FN19 | 10.3 | 44.0 | 50 | 0.025 |
| according to the | | | | |
| invention-200 l/ha | | | | |
| Recipe FN20 | 7.9 | 59.4 | 50 | 0.5 |
| according to the | | | | |
| invention-10 l/ha | | | | |
| Recipe FN20 | 7.3 | 33.4 | 50 | 0.025 |
| according to the | | | | |
| invention-200 l/ha | | | | |
| Recipe FN21 | 3.9 | 50.0 | 50 | 0.5 |
| according to the | | | | |
| invention-10 l/ha | | | | |
| Recipe FN21 | 4.3 | 30.8 | 50 | 0.025 |
| according to the | | | | |
| invention-200 l/ha | | | | |

The results show that recipes FN19, FN20 and FN21 illustrative of the invention shows greater uptake of the a.i. at 10 L/ha spray volume than at 200 L/ha and also compared to the reference recipe FN18.

### INSECTICIDE EXAMPLES

All formulations/recipes were prepared/tested according to the methods described above.

### Example I1 Spirotetramat SC Formulations

TABLE 12
Recipes Spirotetramat SC Formulations

| | | | | | Recipe |
|---|---|---|---|---|---|
| | | Recipe I2 | Recipe I3 | Recipe I4 | I25 |
| | Recipe | according | according | according | according |
| Component | I1 | to the | to the | to the | to the |
| (g/l) | reference | invention | invention | invention | invention |
| Spirotetramat | 75 | 75 | 75 | 75 | 75 |
| Lucramul PS 29 | 40 | 40 | 40 | 40 | 40 |
| Glycerin | 100 | 100 | 100 | 100 | 100 |
| Rhodopol 23 | 3 | 3 | 3 | 3 | 3 |
| Preventol D7 | 0.8 | 0.8 | 0.8 | 0.8 | 0.8 |
| Proxel GXL | 1.2 | 1.2 | 1.2 | 1.2 | 1.2 |
| 20% | | | | | |
| Silcolapse 426R | 1 | 1 | 1 | 1 | 1 |
| Citric Acid | 1 | 1 | 1 | 1 | 1 |
| Crovol CR 70 | — | 50 | — | — | — |
| Genapol X060 | — | — | 50 | — | — |
| Antarox B848 | — | — | — | 50 | — |
| RME EW 500 | — | — | — | — | 100 |
| Water (add to 1 | fill | fill | Fill | fill | fill |
| litre) | | | | | |

### Cuticle Penetration

The penetration through apple leaf cuticles was determined according to method 12.

TABLE 13
Cuticle penetration spirotetramat SC Formulations

| | | | Uptake | Uptake |
|---|---|---|---|---|
| | % cuticular | % cuticular | enhancing | enhancing |
| | penetration | penetration | surfactant | surfactant |
| | 24 h after | 48 h after | dose | dose % w/v |
| Recipe | application | application | g/ha | (g/100 mL) |
| Recipe I1 not | 3.8 | 6.3 | 0 | 0 |
| according to | | | | |
| the invention- | | | | |
| 10 l/ha | | | | |
| Recipe I1 not | 1.6 | 3.7 | 0 | 0 |
| according to | | | | |
| the invention- | | | | |
| 300 l/ha | | | | |
| Recipe I2 | 11.1 | 17.9 | 50 | 0.5 |
| according to | | | | |
| the invention- | | | | |
| 10 l/ha | | | | |
| Recipe I2 | 6.9 | 12.5 | 50 | 0.016 |
| according to | | | | |
| the invention- | | | | |
| 300 l/ha | | | | |

Formulations applied at 11/ha.

The results show that recipe I2 illustrative of the invention shows greater penetration of the a.i. at 10 L/ha spray volume than at 200 L/ha and also compared to the reference recipe I1.

TABLE 14
Cuticle penetration spirotetramat SC Formulations

| | | | | Uptake |
|---|---|---|---|---|
| | | | Uptake | enhancing |
| | % cuticular | % cuticular | enhancing | surfactant |
| | penetration | penetration | surfactant | dose |
| | 24 h after | 48 h after | dose | % w/v |
| Recipe | application | application | g/ha | (g/100 mL) |
| Recipe I1 not | 11.4 | 20.8 | 0 | 0 |
| according to | | | | |
| the invention- | | | | |
| 10 l/ha | | | | |
| Recipe I1 not | 9.5 | 23.6 | 0 | 0 |
| according to | | | | |
| the invention- | | | | |
| 200 l/ha | | | | |
| Recipe I3 | 14.4 | 28.0 | 50 | 0.5 |
| according to | | | | |
| the invention- | | | | |
| 10 l/ha | | | | |
| Recipe I3 | 13.3 | 30.2 | 50 | 0.025 |
| according to | | | | |
| the invention- | | | | |
| 200 l/ha | | | | |
| Recipe I4 | 20.5 | 35.8 | 50 | 0.5 |
| according to | | | | |
| the invention- | | | | |
| 10 l/ha | | | | |
| Recipe I4 | 15.8 | 28.6 | 50 | 0.025 |
| according to | | | | |
| the invention- | | | | |
| 200 l/ha | | | | |

Formulations applied at 11/ha.

The results show that recipe I3 illustrative of the invention shows greater penetration compared to the reference recipe I1.

The results show that recipe I4 illustrative of the invention shows greater penetration of the a.i. at 10 L/ha spray volume than at 200 L/ha and also compared to the reference recipe I1.

TABLE I5
Cuticle penetration spirotetramat SC Formulations

| | | | | Uptake |
|---|---|---|---|---|
| | | % | Uptake | enhancing |
| | % cuticular | cuticular | enhancing | surfactant |
| | penetration | penetration | surfactant | dose in |
| | 24 h after | 48 h after | dose | spray liquid |
| Recipe | application | application | g/ha | g/100 mL |
| Recipe I1 not | 3.8 | 6.3 | 0 | 0 |
| according to | | | | |
| the invention- | | | | |
| 10 l/ha | | | | |
| Recipe I1 not | 1.6 | 3.7 | 0 | 0 |
| according to | | | | |
| the invention- | | | | |
| 300 l/ha | | | | |
| Recipe I25 | 7.2 | 12.5 | 50 | 0.5 |
| according to | | | | |
| the invention- | | | | |
| 10 l/ha | | | | |
| Recipe I25 | 2.6 | 5.5 | 50 | 0.025 |
| according to | | | | |
| the invention- | | | | |
| 300 l/ha | | | | |

Formulations applied at 1 l/ha.

The results show that recipe I25 illustrative of the invention shows greater penetration of the a.i. at 10 L/ha spray volume than at 200 L/ha. Also, recipe I25 illustrative of the invention shows greater penetration of the a.i@10 L/ha than the standard recipe I1.

### Example I2/Spidoxamat OD Formulations

TABLE I6
Recipes/Spidoxamat OD Formulations

| | | Recipe I6 | Recipe I7 | Recipe I8 |
|---|---|---|---|---|
| | | according | according | according |
| | Recipe I5 | to the | to the | to the |
| Component (g/l) | reference | invention | invention | invention |
| SPIDOXAMATE | 12 | 12 | 12 | 12 |
| Propylene Glycol | 150 | 150 | 150 | 150 |
| Aerosil R812S | 40 | 40 | 40 | 40 |
| Diammonium | 20 | 20 | 20 | 20 |
| Hydrogen | | | | |
| phosphate | | | | |
| Antarox B848 | 20 | 20 | 20 | 50 |
| Crovol CR 70 | — | 50 | — | — |
| Genapol X060 | — | — | 50 | — |
| Dowanol DPM | To volume | To volume | To volume | To volume |
| (add to 1 litre) | | | | |

### Cuticle Penetration

The penetration through apple leaf cuticles was determined according to method 12.

TABLE I7
Cuticle penetration/Spidoxamat OD Formulations

| | | | | Uptake |
|---|---|---|---|---|
| | | | | enhancing |
| | | % | Uptake | surfactant |
| | % cuticular | cuticular | enhancing | dose in |
| | penetration | penetration | surfactant | spray liquid |
| | 24 h after | 48 h after | dose | % w/v |
| Recipe | application | application | g/ha | (g/100 mL) |
| Recipe I5 not | 14.0 | 16.0 | 0 | 0 |
| according to | | | | |
| the invention- | | | | |
| 10 l/ha | | | | |
| Recipe I5 not | 17.4 | 35.1 | 0 | 0 |
| according to | | | | |
| the invention- | | | | |
| 200 l/ha | | | | |
| Recipe I6 | 60.8 | 81.7 | 50 | 0.5 |
| according to | | | | |
| the invention- | | | | |
| 10 l/ha | | | | |
| Recipe I6 | 58.0 | 74.7 | 50 | 0.025 |
| according to | | | | |
| the invention- | | | | |
| 200 l/ha | | | | |
| Recipe I8 | 66.6 | 80.6 | 50 | 0.5 |
| according to | | | | |
| the invention- | | | | |
| 10 l/ha | | | | |
| Recipe I8 | 71.7 | 96.1 | 50 | 0.025 |
| according to | | | | |
| the invention- | | | | |
| 200 l/ha | | | | |

Formulations applied at 1 l/ha.

The results show that recipes I6 and I8 illustrative of the invention shows greater penetration compared to the reference recipe I5.

### Example I3 Spirotetramat OD Formulations

TABLE I8
Recipes Spirotetramat OD Formulations

| | | Recipe I10 | Recipe I11 |
|---|---|---|---|
| | | according | according |
| | Recipe I9 | to the | to the |
| Component (g/l) | reference | invention | invention |
| Spirotetramate | 75 | 75 | 75 |
| Morwet D425 | 5 | 5 | 5 |
| Rhodacal 60/B | 5 | 5 | 5 |
| Atlox 4914 | 20 | 20 | 20 |
| Soprophor TS/10 | 50 | 50 | 50 |
| Leofat OC-0503M | — | 100 | — |
| Lucramul HOT 5902 | — | — | 100 |
| SILFOAM SC 1132 | 0.5 | 0.5 | 0.5 |
| Citric Acid | 2 | 2 | 2 |
| Miglyol 812 N (add to | To volume | To volume | To volume |
| 1 litre) | | | |

### Example I4 Tetraniliprole SC Formulations

TABLE I9
Recipes Tetraniliprole SC Formulations

| | | Recipe | Recipe | Recipe | Recipe |
|---|---|---|---|---|---|
| | | I13 | I14 | I15 | I24 |
| | Recipe | according | according | according | according |
| Component | I12 | to the | to the | to the | to the |
| (g/l) | reference | invention | invention | invention | invention |
| Tetraniliprole | 40.0 | 40.0 | 40.0 | 40.0 | 40.0 |
| Atlox 4913 | 40.0 | 40.0 | 40.0 | 40.0 | 40.0 |
| Morwet IP | 10.0 | 10.0 | 10.0 | 10.0 | 10.0 |
| Synperonic | 15.0 | 15.0 | 15.0 | 15.0 | 15.0 |
| PE/F127 | | | | | |
| Lucramul PS 54 | — | — | — | — | — |
| Atlox 4913 | — | — | — | — | — |
| Citric Acid | 1.0 | 1.0 | 1.0 | 1.0 | 1.0 |
| Rhodopol 23 | 3.0 | 3.0 | 3.0 | 3.0 | 3.0 |
| Sipernat 22 S | 7.5 | 7.5 | 7.5 | 7.5 | 7.5 |
| Crovol CR 70 | — | 50 | — | — | — |
| Genapol X060 | — | — | 50 | — | — |
| Antarox B848 | — | — | — | 50 | — |
| RME EW 500 | — | — | — | — | 100 |
| Kathon CG/ICP | 0.8 | 0.8 | 0.8 | 0.8 | 0.8 |
| Proxel GXL | 1.2 | 1.2 | 1.2 | 1.2 | 1.2 |
| Glycerin | 100.0 | 100.0 | 100.0 | 100.0 | 100.0 |
| SAG1572 | 1.5 | 1.5 | 1.5 | 1.5 | 1.5 |
| Water (add to 1 | fill | fill | fill | fill | fill |
| litre) | | | | | |

### Example I5 Tetraniliprole OD Formulations

TABLE I10
Recipes Tetraniliprole OD Formulations

| | | Recipe I17 | Recipe I18 |
|---|---|---|---|
| | | according | according |
| | Recipe I16 | to the | to the |
| Component (g/l) | reference | invention | invention |
| Tetraniliprole | 40 | 40 | 40 |
| Morwet D425 | 5 | 5 | 5 |
| Rhodacal 60/B | 60 | 60 | 60 |
| Soprophor BSU | 40 | 40 | 40 |
| Antarox B848 | — | 100 | — |
| Lucramul HOT 5902 | — | — | 100 |
| SILFOAM SC 1132 | 0.5 | 0.5 | 0.5 |
| Citric Acid | 2 | 2 | 2 |
| Crodamol DA (add to 1 | To volume | To volume | To volume |
| litre) | | | |

### Example I6 Ethiprole+Imidacloprid SC Formulations

TABLE I11
Recipes Ethiprole + Imidacloprid SC Formulations

| | | Recipe | Recipe | Recipe | Recipe |
|---|---|---|---|---|---|
| | | I20 | I21 | I22 | I23 |
| | Recipe | according | according | according | according |
| Component | I19 | to the | to the | to the | to the |
| (g/l) | reference | invention | invention | invention | invention |
| Ethiprole | 100 | 100 | 100 | 100 | 100 |
| Imidacloprid | 100 | 100 | 100 | 100 | 100 |
| Morwet | 11 | 11 | 11 | 11 | 11 |
| D425 | | | | | |
| Atlox 4913 | 69 | 69 | 69 | 69 | 69 |
| Atlas G | 22 | 22 | 22 | 22 | 22 |
| 5000 | | | | | |
| Citric Acid | 2 | 2 | 2 | 2 | 2 |
| Rhodopol 23 | 4 | 4 | 4 | 4 | 4 |
| Veegum R | 6 | 6 | 6 | 6 | 6 |
| Crovol CR | — | 50 | — | — | — |
| 70 | | | | | |
| Genapol | — | — | 50 | — | — |
| X060 | | | | | |
| Antarox | — | — | — | 50 | — |
| B848 | | | | | |
| RME EW | — | — | — | — | 100 |
| 500 | | | | | |
| Kathon | 0.8 | 0.8 | 0.8 | 0.8 | 0.8 |
| CG/ICP | | | | | |
| Proxel GXL | 1.2 | 1.2 | 1.2 | 1.2 | 1.2 |
| Propylene | 110 | 110 | 110 | 110 | 110 |
| Glycol | | | | | |
| Silcolapse | 3 | 3 | 3 | 3 | 3 |
| 426R | | | | | |
| Water (add | fill | fill | fill | fill | fill |
| to 1 litre) | | | | | |

### Cuticle Penetration

The penetration through apple leaf cuticles was determined according to method 12.

TABLE I12
Cuticle penetration of imidacloprid from
Ethiprole + Imidacloprid SC Formulations

| | | | | Uptake |
|---|---|---|---|---|
| | | | | enhancing |
| | | % | Uptake | surfactant |
| | % cuticular | cuticular | enhancing | dose in |
| | penetration | penetration | surfactant | spray liquid |
| | 24 h after | 48 h after | dose | % w/v |
| Recipe | application | application | g/ha | (g/100 mL) |
| Recipe I19 not | 16.0 | 32.8 | 0 | 0 |
| according to | | | | |
| the invention- | | | | |
| 10 l/ha | | | | |
| Recipe I19 not | 54.2 | 72.8 | 0 | 0 |
| according to | | | | |
| the invention- | | | | |
| 200 l/ha | | | | |
| Recipe I21 | 33.0 | 58.2 | 50 | 0.5 |
| according to | | | | |
| the invention- | | | | |
| 10 l/ha | | | | |
| Recipe I21 | 64.4 | 77.6 | 50 | 0.025 |
| according to | | | | |
| the invention- | | | | |
| 200 l/ha | | | | |
| Recipe I22 | 45.8 | 69.1 | 50 | 0.5 |
| according to | | | | |
| the invention- | | | | |
| 10 l/ha | | | | |
| Recipe I22 | 97.0 | 106.1 | 50 | 0.25 |
| according to | | | | |
| the invention- | | | | |
| 200 l/ha | | | | |

Formulations applied at 1 l/ha.

The results show that recipe I21 illustrative of the invention shows greater penetration of Imidacloprid 48 h after application compared to the reference recipe I19.

The results show that recipe I22 illustrative of the invention shows greater penetration of Imidacloprid at comparable water volume use rates than the reference recipe I19.

TABLE I13
Cuticle penetration of ehtiprole from
Ethiprole + Imidacloprid SC Formulations

| | | | | Uptake |
|---|---|---|---|---|
| | | | | enhancing |
| | | % | Uptake | surfactant |
| | % cuticular | cuticular | enhancing | dose in |
| | penetration | penetration | surfactant | spray liquid |
| | 24 h after | 48 h after | dose | % w/v |
| Recipe | application | application | g/ha | (g/100 mL) |
| Recipe I19 not | 2.7 | 6.9 | 0 | 0 |
| according to | | | | |
| the invention- | | | | |
| 10 l/ha | | | | |
| Recipe I19 not | 1.9 | 4.6 | 0 | 0 |
| according to | | | | |
| the invention- | | | | |
| 200 l/ha | | | | |
| Recipe I21 | 5.7 | 12.8 | 50 | 0.5 |
| according to | | | | |
| the invention- | | | | |
| 10 l/ha | | | | |
| Recipe I21 | 3.1 | 7.0 | 50 | 0.025 |
| according to | | | | |
| the invention- | | | | |
| 200 l/ha | | | | |
| Recipe I22 | 8.2 | 15.5 | 50 | 0.5 |
| according to | | | | |
| the invention- | | | | |
| 10 l/ha | | | | |
| Recipe I22 | 6.3 | 13.2 | 50 | 0.025 |
| according to | | | | |
| the invention- | | | | |
| 200 l/ha | | | | |

Formulations applied at 1 l/ha.

The results show that recipes I21 and I22 illustrative of the invention show greater penetration of Ethiprole at 10 L/ha than at 200 L/ha water volume use rates, and also than the reference recipe I19.

### Example I7 Greenhouse Testing TETRANILIPROLE SC Formulations

Test methodology: application onto upperside of pre-infested 1-leaf cabbage plants, BBCH12, for translaminar activity, 2 replicates. Tracksprayer settings: 10 l/ha applied using Lechler's PWM together with nozzle 652.246; 300 l/ha applied using nozzle TeeJet TP8003E.

TABLE I14
Biological efficacy (in % mortality) against mixed population of Myzus
persicae on pre-infested cabbage, evaluation 7 days after application

| | | | Recipe I13 | Recipe I24 |
|---|---|---|---|---|
| | | | according to | according to |
| Spray volume | Rate of a.i. | Recipe I12 | the | the |
| l/ha | g/ha | reference | invention | invention |
| 300 | 100 | 0 | 30 | 0 |
| 300 | 20 | 0 | 0 | 0 |
| 300 | 4 | 0 | 0 | 0 |
| 10 | 100 | 85 | 100 | 100 |
| 10 | 20 | 0 | 65 | 50 |
| 10 | 4 | 0 | 0 | 0 |

The results show that the recipes according to the invention have higher efficacy at 10 l/ha water volume than at 300 l/ha. Additionally, the recipes according to the invention are slightly more efficacious than the recipes not according to the invention.

### Example I8 Greenhouse Testing Imidacloprid+Ethiprole SC200 Formulation

Test methodology: application onto upperside of soybeans, BBCH12, for contact and oral uptake, 2 replicates; artificial infestation with 10 Southern green stink bugs nymphs. Tracksprayer settings: 10 l/ha applied using Lechler's PWM together with nozzle 652.246; 300 l/ha applied using nozzle TeeJet TP8003E.

TABLE I15
Biological efficacy (in % mortality) against mixed population of Nezara
viridula (N2 nymphs) on soybean, evaluation 3 days after application

| | Rate of a.i. g/ha | | | |
|---|---|---|---|---|
| | (delivered as | | | |
| Spray | recipe I19 not | Rate | | |
| volume | according to the | of adjuvant | | |
| l/ha | invention) | g/ha | % Mortality | |
| 300 | 20 | 0 | 70 | |
| 300 | 4 | 0 | 20 | |
| 300 | 0.8 | 0 | 5 | |
| 10 | 20 | 0 | 80 | |
| 10 | 4 | 0 | 15 | |
| 10 | 0.8 | 0 | 5 | |
| | | Rate | % Mortality | Concentration |
| | Rate of a.i. g/ha | of adjuvant | (tank mix | of adjuvant |
| Spray | (delivered as recipe | Crovol | adjuvanted | in spray |
| volume | I19 not according | CR70G | SC200 | solution |
| l/ha | to the invention) | g/ha | formulation) | (g/l) |
| 300 | 20 | 30 | 100 | 0.1 |
| 300 | 4 | 30 | 30 | 0.1 |
| 300 | 0.8 | 30 | 0 | 0.1 |
| 10 | 20 | 30 | 95 | 3 |
| 10 | 4 | 30 | 85 | 3 |
| 10 | 0.8 | 30 | 30 | 3 |

The results show that the addition of Crovol CR70G improves the biological efficacy of the active ingredients, particularly at 10 l/ha water spray volume

### HERBICIDE EXAMPLES

### Example HB1: WG

TABLE HB1
Recipes HB1, HB2 and HB3.

| | | Recipe HB2 | Recipe HB3 |
|---|---|---|---|
| | Recipe HB1 | according to | according to |
| Component (g/kg) | reference | the invention | the invention |
| Triafamone (a) | 200 | 200 | 200 |
| Supragil WP (c) | 50 | 50 | 50 |
| Morwet D 425 (c) | 200 | 200 | 200 |
| Sokalan K 30 (c) | 20 | 20 | 20 |
| Crovol 70 G (b) | 0 | 150 | 0 |
| Genapol X 60 (b) | 0 | 0 | 150 |
| Rhodorsil Antim EP 6703 (c) | 40 | 40 | 40 |
| Sipernat 50 S (c) | 100 | 100 | 100 |
| Kaolin Tec 1 | 390 | 240 | 240 |

Dose rate: 0.25 kg/ha
The method of preparation used was according to Method 2.

### Cuticle Penetration

The penetration through apple leaf cuticles was determined according to method 12.

TABLE HB2
Cuticle penetration for HB1, HB2 and HB3.

| | | | | Uptake |
|---|---|---|---|---|
| | | | | enhancing |
| | % | % | Uptake | surfactant |
| | cuticular | cuticular | enhancing | dose in |
| | penetration | penetration | surfactant | spray |
| | 24 h after | 48 h after | dose | liquid |
| Recipe | application | application | g/ha | % w/v |
| Recipe | 0.2 | 0.8 | 0 | 0 |
| HB1 not | | | | |
| according | | | | |
| to the | | | | |
| invention- | | | | |
| 10 l/ha | | | | |
| Recipe | 1.3 | 4.9 | 0 | 0 |
| HB1 not | | | | |
| according | | | | |
| to the | | | | |
| invention- | | | | |
| 200 l/ha | | | | |
| Recipe | 2.1 | 12.7 | 37.5 | 0.4 |
| HB2 | | | | |
| according | | | | |
| to the | | | | |
| invention- | | | | |
| 10 l/ha | | | | |
| Recipe | 4.4 | 12.8 | 37.5 | 0.02 |
| HB2 | | | | |
| according | | | | |
| to the | | | | |
| invention- | | | | |
| 200 l/ha | | | | |
| Recipe HB | 2.3 | 5.8 | 37.5 | 0.4 |
| 3according | | | | |
| to the | | | | |
| invention- | | | | |
| 10 l/ha | | | | |
| Recipe | 5.1 | 12.4 | 37.5 | 0.02 |
| HB3 | | | | |
| according | | | | |
| to the | | | | |
| invention- | | | | |
| 200 l/ha | | | | |

Formulations applied at 0.25 kg/ha.

The results show that recipe HB2 illustrative of the invention shows greater penetration of the a.i. Triafamone at 10 L/ha spray volume than at 200 L/ha and also compared to the reference recipe HB1. Also recipe HB3 shows better penetration at low spray volume compared to the reference recipe HB1 at low spray volume.

### BOP-CUPET “Uptake” Tests

The penetration through apple leaf cuticles was determined according to method described as cuticle penetration test.

### Example HB2a: SC

TABLE HB3
Recipes HB4, HB5 and HB6.

| | Recipe | Recipe HB5 | Recipe HB6 |
|---|---|---|---|
| | HB4 | according to | according to |
| Component (g/kg) | reference | the invention | the invention |
| TEMBOTRIONE (a) | 100.00 | 100.00 | 100.00 |
| ISOXADIFEN-ETHYL (a) | 50.00 | 50.00 | 50.00 |
| ATLOX G 5000 (c) | 12.20 | 12.20 | 12.20 |
| SYNPERONIC A7 (c) | 12.20 | 12.20 | 12.20 |
| ATLOX 4913 (c) | 36.60 | 36.60 | 36.60 |
| Synperonic PE/F 127 (c) | 16.00 | 16.00 | 16.00 |
| 1,2-PROPYLENE | 61.00 | 61.00 | 61.00 |
| GLYCOL (c) | | | |
| SILICOLAPSE 454 (c) | 2.44 | 2.44 | 2.44 |
| ACTICIDE MBS (c) | 2.44 | 2.44 | 2.44 |
| Genapol X0 60 (b) | 0.00 | 100.00 | 0.00 |
| Tween 80 (b) | 0.00 | 0.00 | 100.00 |
| RHODOPOL 23 (c) | 2.20 | 2.20 | 2.20 |
| WATER (add to 1 litre) | to volume | to volume | to volume |

The method of preparation used was according to Method 1.

### Example HB2b: SC

TABLE HB4
Recipes HB7, HB8 and HB9.

| | Recipe HB7 | Recipe HB8 | Recipe HB9 |
|---|---|---|---|
| | according to | according to | according to |
| Component (g/kg) | the invention | the invention | the invention |
| TEMBOTRIONE (a) | 100.00 | 100.00 | 100.00 |
| ISOXADIFEN-ETHYL (a) | 50.00 | 50.00 | 50.00 |
| ATLOX G 5000 (c) | 12.20 | 12.20 | 12.20 |
| SYNPERONIC A7 (c) | 12.20 | 12.20 | 12.20 |
| ATLOX 4913 (c) | 36.60 | 36.60 | 36.60 |
| Synperonic PE/F 127 (c) | 16.00 | 16.00 | 16.00 |
| 1,2-PROPYLENE | 61.00 | 61.00 | 61.00 |
| GLYCOL (c) | | | |
| SILICOLAPSE 454 (c) | 2.44 | 2.44 | 2.44 |
| ACTICIDE MBS (c) | 2.44 | 2.44 | 2.44 |
| Triton CG-50 (b) | 100.00 | 0.00 | 0.00 |
| Sophorphor 796/P (b) | 0.00 | 100.00 | 0.00 |
| Disflamoll TOF (b) | 0.00 | 0.00 | 140.00 |
| RHODOPOL 23 (c) | 2.20 | 2.20 | 2.20 |
| WATER (add to 1 litre) | to volume | to volume | to volume |

The method of preparation used was according to Method 1.

TABLE HB5
Cuticle penetration for HB4-HB9 (Tembotrione)

| | | | | Uptake |
|---|---|---|---|---|
| | | | | enhancing |
| | % | % | Uptake | surfactant |
| | cuticular | cuticular | enhancing | dose in |
| | penetration | penetration | surfactant | spray |
| | 20 h after | 53 h after | dose | liquid |
| Recipe | application | application | g/ha | % w/v |
| Recipe HB4 not | 4.7 | 10.0 | 0 | 0 |
| according to the | | | | |
| invention - | | | | |
| 10 l/ha | | | | |
| Recipe HB4 not | 3.3 | 6.4 | 0 | 0 |
| according to the | | | | |
| invention - | | | | |
| 200 l/ha | | | | |
| Recipe HB5 | 11.8 | 23.6 | 100 | 1 |
| according to the | | | | |
| invention - | | | | |
| 10 l/ha | | | | |
| Recipe HB5 | 2.1 | 6.2 | 100 | 0.05 |
| according to the | | | | |
| invention - 200 | | | | |
| l/ha | | | | |
| Recipe HB6 | 26.8 | 59.8 | 100 | 1 |
| according to the | | | | |
| invention - | | | | |
| 10 l/ha | | | | |
| Recipe HB6 | 5.0 | 8.0 | 100 | 0.05 |
| according to the | | | | |
| invention - | | | | |
| 200 l/ha | | | | |
| Recipe HB7 | 14.6 | 32.7 | 100 | 1 |
| according to the | | | | |
| invention - | | | | |
| 10 l/ha | | | | |
| Recipe HB7 | 8.3 | 19.3 | 100 | 0.05 |
| according to the | | | | |
| invention - | | | | |
| 200 l/ha | | | | |
| Recipe HB8 | 15.0 | 29.7 | 100 | 1 |
| according to the | | | | |
| invention - | | | | |
| 10 l/ha | | | | |
| Recipe HB8 | 6.9 | 16.2 | 100 | 0.05 |
| according to the | | | | |
| invention - | | | | |
| 200 l/ha | | | | |
| Recipe HB9 | 14.7 | 28.4 | 140 | 1.4 |
| according to the | | | | |
| invention - | | | | |
| 10 l/ha | | | | |
| Recipe HB9 | 8.4 | 13.4 | 140 | 0.07 |
| according to the | | | | |
| invention - | | | | |
| 200 l/ha | | | | |

Formulations applied at 1 L/ha.

The results show that recipes HB5-HB9 illustrative of the invention show greater penetration of the Tembotrione at 10 L/ha spray volume compared to the reference recipe HB4 and greater than at 200 L/ha.

### Greenhouse

### Efficacy Data

TABLE HB6a
Additive dose g/ha for each treatment.

| HB4 | | | | |
|---|---|---|---|---|
| reference | | | | |
| Spray volume | Rate of SC | Rate of a.i. | Additive dose | Additive |
| l/ha | applied l/ha | g/ha | g/ha | dose % w/v |
| 200 | 1 | 50 + 100 | 100 | 0 |
| 10 | 1 | 50 + 100 | 100 | 0 |

TABLE HB6b
Additive dose g/ha for each treatment

| HB5, HB6 | | | | |
|---|---|---|---|---|
| and HB7 | | | | |
| Spray volume | Rate of SC | Rate of a.i. | Additive | Additive |
| l/ha | applied l/ha | g/ha | dose g/ha | dose % w/v |
| 200 | 1 | 50 + 100 | 100 | 0.05 |
| 10 | 1 | 50 + 100 | 100 | 1 |

TABLE HB7a
Biological efficacy on Echinochloa crus-galli (ECHCG).

| ECHCG | HB4 | HB5 | HB6 | HB7 |
|---|---|---|---|---|
| 200 l/ha | 96 | 96 | 96 | 97 |
| 10 l/ha | 80 | 93 | 97 | 96 |

TABLE HB7b
Biological efficacy on Alopecurus myosuroides (ALOMY).

| ALOMY | HB4 | HB5 | HB6 | HB7 |
|---|---|---|---|---|
| 200 l/ha | 60 | 78 | 88 | 20 |
| 10 l/ha | 8 | 73 | 90 | 90 |

TABLE HB7c
Biological efficacy on Amaranthus retroflexus (AMARE).

| AMARE | HB4 | HB5 | HB6 | HB7 |
|---|---|---|---|---|
| 200 l/ha | 98 | 100 | 100 | 98 |
| 10 l/ha | 48 | 100 | 100 | 100 |

TABLE HB7d
Biological efficacy on Abutilon theophrasti (ABUTH).

| ABUTH | HB4 | HB5 | HB6 | HB7 |
|---|---|---|---|---|
| 200 l/ha | 88 | 96 | 90 | 90 |
| 10 l/ha | 60 | 98 | 90 | 88 |

The results in table HB7a-d show that recipes HB5, HB6 and HB7 illustrative of the invention show greater or same efficacy at 10 L/ha spray volume as at 200 L/ha on different weeds and also compared to the reference recipe HB4.

### Example HB3: OD

TABLE HB8
Recipes HB10, HB11, HB12 and HB13 .

| | | Recipe HB11 | Recipe HB12 | Recipe HB13 |
|---|---|---|---|---|
| | Recipe HB10 | according to | according to | according to the |
| Component (g/kg) | reference | the invention | the invention | invention |
| THIENCARBAZONE- | 10 | 10 | 10 | 10 |
| METHYL (a) | | | | |
| MEFENPYR-DIETHYL | 60 | 60 | 60 | 60 |
| (a) | | | | |
| RAPESEED OIL | 0 | 200 | 0 | 0 |
| METHYL ESTER (b) | | | | |
| GENAPOL X 090 (b) | 0 | 0 | 200 | 0 |
| DISFLAMOLL TOF (b) | 0 | 0 | 0 | 200 |
| BENTONE 34(c) | 20 | 20 | 20 | 20 |
| CALSOGEN AR 100 | 80 | 80 | 80 | 80 |
| ND (c) | | | | |
| EMULSOGEN EL400 | 60 | 60 | 60 | 60 |
| (c) | | | | |
| PROPYLENE | | | | |
| CARBONATE (c) | 2 | 2 | 2 | 2 |
| SILICOLAPSE 482 | 1.5 | 1.5 | 1.5 | 1.5 |
| SODIUM | 2 | 2 | 2 | 2 |
| CARBONATE (c) | | | | |
| SOLVESSO 200ND | to volume | to volume | to volume | to volume |
| (add to 1 litre) | | | | |

The method of preparation used was according to Method 4.

TABLE HB9a
Additive dose g/ha for each treatment

| HB10 | | | | |
|---|---|---|---|---|
| reference | | | | |
| | | | | Additive |
| | | | Additive | dose |
| Spray volume | Rate ofS C | Rate of a.i. | dose | In spray |
| l/ha | applied l/ha | g/ha | g/ha | liquid % w/v |
| 200 | 1.5 | 15 + 90 | 0 | 0 |
| 10 | 1.5 | 15 + 90 | 0 | 0 |
| 200 | 0.75 | 7.5 + 45 | 0 | 0 |
| 10 | 0.75 | 7.5 + 45 | 0 | 0 |

TABLE HB9b
Additive dose g/ha for each treatment

| HB11, HB12 | | | | |
|---|---|---|---|---|
| and HB13 | | | | |
| | | | | Additive |
| | | | Additive | dose |
| Spray volume | Rate of OD | Rate of a.i. | dose | In spray |
| l/ha | applied l/ha | g/ha | g/ha | liquid % w/v |
| 200 | 1.5 | 15 + 90 | 300 | 0.15 |
| 10 | 1.5 | 15 + 90 | 300 | 3 |
| 200 | 0.75 | 7.5 + 45 | 150 | 0.075 |
| 10 | 0.75 | 7.5 + 45 | 150 | 1.5 |

TABLE HB10a
Biological efficacy on Setaria viridis (SETVI) @ 7.5 g TCM

| SETVI | HB10 | HB11 | HB12 | HB13 |
|---|---|---|---|---|
| 200 l/ha | 90 | 95 | 90 | 90 |
| 10 l/ha | 80 | 90 | 90 | 90 |

TABLE HB10b
Biological efficacy on Avena fatua (AVEFA) @ 7.5 g TCM

| AVEFA | HB10 | HB11 | HB12 | HB13 |
|---|---|---|---|---|
| 200 l/ha | 20 | 80 | 50 | 40 |
| 10 l/ha | 40 | 80 | 80 | 60 |

TABLE HB10c
Biological efficacy on Hordeum murinum (HORMU) @ 7.5 g TCM

| HORMU | HB10 | HB11 | HB12 | HB13 |
|---|---|---|---|---|
| 200 l/ha | 20 | 70 | 20 | 30 |
| 10 l/ha | 40 | 80 | 80 | 60 |

TABLE HB10d
Biological efficacy on Pharbitis purpurea (PHBPU) @ 15 g TCM

| PHBPU | HB10 | HB11 | HB12 | HB13 |
|---|---|---|---|---|
| 200 l/ha | 90 | 90 | 90 | 60 |
| 10 l/ha | 70 | 90 | 90 | 90 |

TABLE HB10e
Biological efficacy on Abutilon theophrasti (ABUTH) @ 15g TCM

| ABUTH | HB10 | HB11 | HB12 | HB13 |
|---|---|---|---|---|
| 200 l/ha | 90 | 80 | 90 | 60 |
| 10 l/ha | 40 | 90 | 80 | 85 |

The results in table HB10a-e show that recipes HB11, HB12 and HB13 illustrative of the invention show greater or same efficacy at 10 L/ha spray volume as at 200 L/ha on different weeds and also compared to the reference recipe HB10.

1: An agrochemical formulation, comprising
a) one or more active ingredients,
b) one or more uptake enhancers,
c) other formulants, and
d) one or more carriers to volume,
wherein b) is present in an amount from 5 to 200 g/l.

2: The agrochemical formulation according to claim 1, wherein b) is selected from the group consisting of
sunflower oil, rapeseed oil, corn oil, soybean oil, rice bran oil, olive oil;
ethylhexyl oleate, ethylhexyl palmitate, ethylhexyl myristate/laurate, ethylhexyl laurate, ethylhexyl caprylate/caprate, iso-propyl myristate, iso-propyl palmitate, methyl oleate, methyl palmitate, ethyl oleate, rape seed oil methyl ester, soybean oil methyl ester, rice bran oil methyl ester,
Mineral oils and white oil;
tris-alkyl-phosphate esters, preferably tris (2-ethylhexyl) phosphate,
i. ethoxylated branched alcohols with 2-20 EO units;
ii. methyl end-capped, ethoxylated branched alcohols comprising 2-20 EO units;
iii. ethoxylated coconut alcohols comprising 2-20 EO units;
iv. ethoxylated C12/15 alcohols comprising 2-20 EO units;
v. propoxy-ethoxylated alcohols, branched or linear,
vi. propoxy-ethoxylated fatty acids, Me end-capped,
vii. alkyl ether citrate surfactants;
viii. ethoxylated mono- or diesters of glycerine comprising fatty acids with 8-18 carbon atoms and an average of 10-40 EO units;
ix. castor oil ethoxylates comprising an average of 5-40 EO units,
x. ethoxylated oleic acid comprising 2-20 EO units; and
xi. ethoxylated sorbitan fatty acid esters comprising fatty acids with 8-18 carbon atoms and an average of 10-50 EO units.

3: The agrochemical formulation according to claim 1, wherein b) is selected from the group consisting of tris (2-ethylhexyl) phosphate, rapeseed oil methyl esters, ethoxylated coconut alcohols, ethoxylated branched alcohols, propoxy-ethoxylated alcohols, ethoxylated mono- or diesters of glycerine comprising fatty acids with 8-18 carbon atoms and an average of 10-40 EO units, ethoxylated oleic acid and mineral oils.

4: The agrochemical formulation according to claim 1, wherein a) is present in an amount from 5 to 300 g/l, preferably from 10 to 280 g/l, and most preferred from 10 to 250 g/l.

5: The agrochemical formulation according to claim 1, wherein b) is present in an amount from 5 to 200 g/l, preferably from 10 to 150 g/l, and most preferred from 10 to 130 g/l.

6: The agrochemical formulation according to claim 1, wherein c) is present in 4 to 250 g/l, preferably from 8 to 120 g/l, and most preferred from 10 to 80 g/l.

7: The agrochemical formulation according to claim 1, wherein the active ingredient is selected from the group consisting of bixafen, fluoxapiprolin, inpyrfluxam, isoflucypram, prothioconazole, tebuconazole, trifloxystrobin, ethiprole, imidacloprid, spidoxamat, spirotetramat, tetraniliprole, thiencarbazone-methyl, triafamone, isoxadifen-ethyl and mefenpyr-diethyl.

8: The agrochemical formulation according to claim 1, wherein component c) comprises at least one non-ionic surfactant and/or ionic surfactant (c1), one rheological modifier (c2), one antifoam substance (c3), and at least one antifreeze agent (c4).

9: The agrochemical formulation according to claim 1, comprising the components a) to e) in the following amounts
a) from 5 to 300 g/l, preferably from 10 to 280 g/l, and most preferred from 10 to 250 g/l,
b) from 5 to 250 g/l, preferably from 20 to 200 g/l, and most preferred from 30 to 150 g/l,
c1) from 4 to 250 g/l, preferably from 8 to 120 g/l, and most preferred from 10 to 80 g/l,
c2) from 0 to 60 g/l, preferably from 1 to 20 g/l, and most preferred from 2 to 10 g/l,
c3) from 0 to 30 g/l, preferably from 0.5 to 20 g/l, and most preferred from 1 to 12 g/l,
c4) from 0 to 200 g/l, preferably from 5 to 150 g/l, and most preferred from 10 to 120 g/l,
c5) from 0 to 200 g/l, preferably from 0.1 to 120 g/l, and most preferred from 0.5 to 80 g/l, and
d) carrier to volume.

10: The agrochemical composition according to claim 1, wherein the formulation is applied at a spray volume of between 1 and 20 l/ha, preferably 2 and 15 l/ha, more preferably 5 and 15 l/ha.

11: A method of applying an agrochemical formulation according to claim 1, onto crops, comprising applying the formulation at a spray volume of between 1 and 20 l/ha, preferably 2 and 15 l/ha, and more preferably 5 and 15 l/ha.

12: The method according to claim 11, wherein the applied amount of a) to the crop is between 2 and 150 g/ha, preferably between 5 and 120 g/ha, and more preferred between 20 and 200 g/ha.

13: The method according to claim 11, wherein the uptake enhancer b) is preferably applied from 5 g/ha to 150 g/ha, more preferably from 7.5 g/ha to 100 g/ha, and most preferred from 10 g/ha to 60 g/ha.

14: The method according to claim 11, wherein the formulation is applied on plants or crops with textured leaf surfaces.

15: A method for controlling harmful organisms, comprising applying an agrochemical formulation according to claim 1 by an unmanned aerial vehicle (UAV), an unmanned guided vehicle (UGV), or a pulse-width-module (PWM).

16: A method of controlling harmful organisms, comprising contacting the harmful organisms, their habitat, their hosts, such as plants and seed, and the soil, the area and the environment in which they grow or could grow, but also of materials, plants, seeds, soil, surfaces or spaces which are to be protected from attack or infestation by organisms that are harmful to plants, with an effective amount of an agrochemical formulation according to claim 1, characterized in that the composition is applied by an unmanned aerial vehicle (UAV), an unmanned guided vehicle (UGV), or a pulse-width-module (PWM).
